(19) United States
(12) Patent Application Publication
(10) Pub. No.: US 2026/0214238 A1
(43) Pub. Date: Jul. 23, 2026

(54) ENCODER FOR ENCODING A MEDIA SIGNAL

(71) Applicant: Fraunhofer-Gesellschaft zur Foerderung der angewandten Forschung e.V., Munich (DE)

(72) Inventors: Anastasia HENKEL, Berlin (DE); Christian HELMRICH, Berlin (DE); Tobias HINZ, Berlin (DE); Jens BRANDENBURG, Berlin (DE); Christian BARTNIK, Berlin (DE); Adam WIECKOWSKI, Berlin (DE); Benjamin BROSS, Berlin (DE); Detlev MARPE, Berlin (DE); Thomas WIEGAND, Berlin (DE)

(21) Appl. No.: 19/438,388

(22) Filed: Dec. 31, 2025

Related U.S. Application Data
(63) Continuation of application No. PCT/EP2024/068622, filed on Jul. 2, 2024.

(30) Foreign Application Priority Data
Jul. 7, 2023 (EP) 23184196.6

(51) Int. Cl. H04N 19/142; H04N 19/147; H04N 19/172

(52) U.S. Cl. CPC H04N 19/142; H04N 19/147; H04N 19/172

(57) ABSTRACT

An encoder and method for encoding a media signal is presented. The encoder is configured to perform a first-pass encoding of the media signal with restricting the first-pass encoding onto a set of frames out of a sequence of immediately consecutive frames of the media signal and using a probe quantization parameter, QP, for each of the set of frames of the media signal, so as to obtain a first-pass bitrate for each of the set of frames, determine, based on the first-pass bitrate for each of the set of frames, a start QP for each of the sequence of immediately consecutive frames; and perform a second-pass encoding of the media signal with using the start QP for each of the sequence of immediately consecutive frames, wherein the sequence of immediately consecutive frames is a group of pictures having a hierarchical referencing structure with temporal layers including a temporal base layer 0 up to a highest temporal layer N-1 and the encoder is configured to select the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N, and/or the encoder is configured to perform scene detection to detect scene changes, and select the set of frames out of the sequence of immediately consecutive frames depending on whether any of the scene changes falls into the sequence of immediately consecutive frames so that the set of frames represents a sequentially sub-sampled subset of a sequence of immediately consecutive frames of the media signal in case of none of the scene changes falling into the sequence of immediately consecutive frames, and/or the encoder is configured to perform scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls.

### CROSS-REFERENCES TO RELATED APPLICATIONS

This application is a continuation of copending International Application No. PCT/EP2024/068622, filed Jul. 2, 2024, which is incorporated herein by reference in its entirety, and additionally claims priority from European Applications No. EP 23 184 196.6, filed Jul. 7, 2023, which is incorporated herein by reference in its entirety.

Embodiment according to the invention relate to an encoder for encoding a media signal, e.g., by performing a first-pass restricted to a set of frames and/or a spatially sub-sampled version of the media signal. Embodiments according to the invention relate to a Two-Pass Video Encoding Concept, e.g., realizing a fast first pass in two-pass video encoding, e.g., using sub-sampling.

### BACKGROUND OF THE INVENTION

Rate control (RC) methods are mandatory in real-world encoding applications. Instead of a fixed quantization parameter (QP) encoding, where the final bitrate is unpredicted, RC enables targeting a specific rate during encoding. The VVC software encoder VVenC for example supports so called “one-pass” and “two-pass” rate control modes. In the following the rate control of VVenC will be used as an exemplary embodiment of the present invention.

The RC solutions in VVenC consist of two stages. The first stage is an analysis stage in which coding statistics, specifically the rate of encoding the frame with a fixed QP, are collected for each frame, over a sliding window for one-pass rate control, or over the entire video input for two-pass rate control. This first analysis stage, in the remainder also designated as the first pass, is followed by the encoding stage also called the second pass. The first pass is faster than the second pass, because of modifications in the encoder configuration, which results in a reduced encoder search space for the first pass. For instance, the interval of block sizes might be restricted in the first pass compared to the second pass: Additionally or alternatively, a reduced set of coding tools might be tested in terms of rate-distortion optimization in the first pass compared to the second pass. For instance, certain tools might be excluded from being used in the first pass such as dependent quantization. In the second pass, the video is encoded again with the unmodified encoder configuration using the coding statistics of the first pass. The second pass might be rate controlled while pass 1 is not. Both passes may inherit a block-wise modification of the underlying frame QP, i.e. the probe QP in case of pass 1 and the start QP in case of pass 2, such as depending on certain coding complexity measures such as an activity measure or the like. However, the modification operates relative to the underlying frame QP. Optionally, both pass 1 and pass 2, may allow for a micro modification of the block-wise modified frame QP in rate-distortion sense, but the range of modification might, for instance, be lower than the range of modification realized depending on the coding complexity measure. In addition, the encoder may perform an input picture pre-filter stage, e.g. motion compensated temporal filtering (MCTF), before the first pass, to improve coding efficiency. The VVenC RC method uses video dimensions (width and height) and the target bitrate to determine the overall QP for the first pass. When reencoding the input in the second pass, the approximation of the target bitrate occurs with the framewise adjustment of the QP, based on the statistics from the first pass and the actual bits used to encode the previous frames from the current pass. Although using a fast configuration, the additional encoding in the first analysis pass requires additional time which adds to the overall processing time of the video encoding. To enable the RC scheme to operate in on-the-fly application with lower latency, the first pass can be applied not on the entire input, but for a Group-Of-Pictures (GOP)[1]. Here, a GOP is defined as group of consecutive pictures with a fixed picture referencing structure and, if hierarchical referencing is used, various temporal layer (TL) (as exemplarily illustrated in FIG. 4). The default in VVenC is a GOP with 32 pictures and a hierarchical referencing structure with 6 TLs. Such an approach in VVenC is called “one-pass” encoding because the first GOP-based look-ahead pass, executing the analysis stage, is never exposed to the user, even though it still executes two full passes, but interleaved. The coding statistics can be collected using a short look-ahead window, whose length is usually set equal to the GOP size, in the one-pass RC application, with the results being directly applied for the final encoding. Hence in the following, this type of RC will be called “look-ahead based RC” or “GOP-wise RC”. In other words, according to the look-ahead based RC, the two first- and second pass encodings are performed in an interleaved manner such as in a manner so that the application of the second-pass encoding onto a current sequence of immediately consecutive frames of the media signal has begun before the application of the first-pass encoding onto a next one of the consecutive sequences of immediately consecutive frames. Nevertheless, two-pass or look-ahead based RC, both applications occur with encoding time increase imposed by the first pass encoding duration. An embodiment of the described first pass sub-sampling invention allows to reduce the runtime of both RC methods and RC method in general that process pictures in a complete first pass or using a look-ahead window.

This is achieved by the subject matter of the independent claims of the present application.

Further embodiments according to the invention are defined by the subject matter of the dependent claims of the present application.

### SUMMARY

An embodiment may have an encoder for encoding a media signal, configured to perform a first-pass encoding of the media signal with restricting the first-pass encoding onto a set of frames out of a sequence of immediately consecutive frames of the media signal and using a probe QP for each of the set of frames of the media signal, so as to acquire a first-pass bitrate for each of the set of frames, determine, based on the first-pass bitrate for each of the set of frames, a start QP for each of the sequence of immediately consecutive frames; and perform a second-pass encoding of the media signal with using the start QP for each of the sequence of immediately consecutive frames, wherein the sequence of immediately consecutive frames is a group of pictures having a hierarchical referencing structure with temporal layers including a temporal base layer 0 up to a highest temporal layer N-1 and the encoder is configured to select the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N, and/or the encoder is configured to perform scene detection to detect scene changes, and select the set of frames out of the sequence of immediately consecutive frames depending on whether any of the scene changes falls into the sequence of immediately consecutive frames so that the set of frames represents a sequentially sub-sampled subset of a sequence of immediately consecutive frames of the media signal in case of none of the scene changes falling into the sequence of immediately consecutive frames, and/or the encoder is configured to perform scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls.

Another embodiment may have an encoder for encoding a media signal, configured to perform a first-pass encoding of a spatially sub-sampled version of the media signal using a probe QP so as to acquire first-pass bitrates for frames of the media signal, determine, based on the first-pass bitrates, start QPs for the frames of the media signal; and perform a second-pass encoding of a not spatially sub-sampled version of the media signal with using the start QPs.

Another embodiment may have a method for encoding a media signal, the method comprising performing a first-pass encoding of the media signal with restricting the first-pass encoding onto a set of frames out of a sequence of immediately consecutive frames of the media signal and using a probe QP for each of the set of frames of the media signal, so as to acquire a first-pass bitrate for each of the set of frames, determining, based on the first-pass bitrate for each of the set of frames, a start QP for each of the sequence of immediately consecutive frames; and performing a second-pass encoding of the media signal with using the start QP for each of the sequence of immediately consecutive frames, wherein the sequence of immediately consecutive frames is a group of pictures having a hierarchical referencing structure with temporal layers including a temporal base layer 0 up to a highest temporal layer N-1 and the method comprise selecting the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N, and/or wherein the method comprises performing scene detection to detect scene changes, and select the set of frames out of the sequence of immediately consecutive frames depending on whether any of the scene changes falls into the sequence of immediately consecutive frames so that the set of frames represents a sequentially sub-sampled subset of a sequence of immediately consecutive frames of the media signal in case of none of the scene changes falling into the sequence of immediately consecutive frames, and/or wherein the method comprises performing scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls.

Another embodiment may have a method for encoding a media signal, the method comprising performing a first-pass encoding of a spatially sub-sampled version of the media signal using a probe QP so as to acquire first-pass bitrates for frames of the media signal, determining, based on the first-pass bitrates, start QPs for the frames of the media signal; and performing a second-pass encoding of a not spatially sub-sampled version of the media signal with using the start QPs.

Another embodiment may have a non-transitory digital storage medium having a computer program stored thereon to perform the method for encoding a media signal, the method comprising performing a first-pass encoding of the media signal with restricting the first-pass encoding onto a set of frames out of a sequence of immediately consecutive frames of the media signal and using a probe QP for each of the set of frames of the media signal, so as to acquire a first-pass bitrate for each of the set of frames, determining, based on the first-pass bitrate for each of the set of frames, a start QP for each of the sequence of immediately consecutive frames; and performing a second-pass encoding of the media signal with using the start QP for each of the sequence of immediately consecutive frames, wherein the sequence of immediately consecutive frames is a group of pictures having a hierarchical referencing structure with temporal layers including a temporal base layer 0 up to a highest temporal layer N-1 and the method comprise selecting the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N, and/or wherein the method comprises performing scene detection to detect scene changes, and select the set of frames out of the sequence of immediately consecutive frames depending on whether any of the scene changes falls into the sequence of immediately consecutive frames so that the set of frames represents a sequentially sub-sampled subset of a sequence of immediately consecutive frames of the media signal in case of none of the scene changes falling into the sequence of immediately consecutive frames, and/or wherein the method comprises performing scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls, when said computer program is run by a computer.

Another embodiment may have a non-transitory digital storage medium having a computer program stored thereon to perform the method for encoding a media signal, the method comprising performing a first-pass encoding of a spatially sub-sampled version of the media signal using a probe QP so as to acquire first-pass bitrates for frames of the media signal, determining, based on the first-pass bitrates, start QPs for the frames of the media signal; and performing a second-pass encoding of a not spatially sub-sampled version of the media signal with using the start QPs, when said computer program is run by a computer.

Another embodiment may have a data stream having encoded therein a media signal using a method according to the invention.

In accordance with a first main aspect of the present invention, an encoder for encoding a media signal is configured to perform a first-pass encoding of the media signal with restricting the first-pass encoding onto a set of frames out of a sequence of immediately consecutive frames (e.g. immediately consecutive in terms of coding order with, for instance, forming a contiguous temporal section of the media signal) of the media signal and using a probe quantization parameter (QP) for each of the set of frames of the media signal, so as to obtain a first-pass bitrate for each of the set of frames, determine, based on the first-pass bitrate for each of the set of frames, a start quantization parameter (QP) for each of the sequence of immediately consecutive frames; and perform a second-pass encoding of the media signal with using the start QP for each of the sequence of immediately consecutive frames. Further is provided at least one of the following
i) the sequence of immediately consecutive frames is a group of pictures (GOP) having a hierarchical referencing structure with temporal layers including a temporal base layer 0 (e.g. a temporal layer 0 inevitably to be decoded) up to a highest temporal layer N-1 (e.g. and temporal layers 0<n<N the decoding which necessitates a previous decoding of temporal layers m<n) and the encoder is configured to select the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N (e.g. 2<k<N, e.g. k=3),
ii) the encoder is configured to perform scene detection to detect scene changes, and select the set of frames out of the sequence of immediately consecutive frames depending on whether any of the scene changes falls into the sequence of immediately consecutive frames so that the set of frames represents a sequentially sub-sampled subset of a sequence of immediately consecutive frames of the media signal in case of none of the scene changes falling into the sequence of immediately consecutive frames, and
iii) the encoder is configured to perform scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls.

Since the frames of the sequence of immediately consecutive frames define different time instances or time slots, the encoder described above essentially realizes a temporal sub-sampling, due to a restriction of the first-pass encoding to the set of frames out of a sequence of immediately consecutive frames. It has been recognized that restricting the first-pass encoding onto a set of frames allows obtaining a first-pass bitrate that can still be adequately representative of all (or most) other frames of the sequence of immediately consecutive frames. Therefore, the amount of frames for first-pass encoding can be significantly reduced, which can reduce encoding time, encoding processing requirements and/or encoding complexity. The restricted first-pass encoding can therefore improve a compromise between coding accuracy and coding complexity. Since the first-pass bitrate may be, at least to a certain degree, representative for the remaining frames of the sequence of immediately consecutive frames, a start QP determined based on the first-pass bitrate may form a suitable quantization parameter also for frames, for which no first-pass encoding has been performed. Therefore, the second-pass encoding each of the sequence of immediately consecutive frames using the start QP (or a bitrate determined from the start QP) thus determined may yield a similar result as if the first-pass encoding would have been performed with all frames of the sequence of sequence of immediately consecutive frames. A compromise between a quality or accuracy of the second-pass encoding and the encoding complexity may therefore be improved.

Aspect i defines a hierarchical referencing structure with temporal layers, wherein restriction of the first-pass encoding is essentially realized by proper subsets that are defined in higher temporal layers. Higher temporal layers are more likely to reference frames from lower temporal layers while not forming a reference for lower temporal layers. Therefore, omitting frames in higher temporal layers has a less or no negative impact on the referencing structure of the sequence of immediately consecutive frames. Furthermore, frames in higher temporal layers are more likely to be omitted in transmission of an encoded bit stream (e.g., due to a limited transmission bandwidth). Therefore, the risk of inaccuracies for a determined start QP is shifted to frames that are more likely to not be decoded. In other words, a more accurate start QP is determined for frames of lower temporal layers that are more likely to be transmitted and decoded.

Aspect ii defines detection of scene changes. The restriction of the first-pass coding benefits from frames within the sequence of immediately consecutive frames likely having similar characteristics and therefore a similar first-pass bitrate. It has been recognized that the probability of similar characteristics may decrease after a scene change. By selecting the set of frames that represent a sequentially sub-sampled subset in case of none of the scene changes falling into the sequence of immediately consecutive frames, the selection is more likely to have similar characteristics as the remaining frames. As a result, the start QP determined for each of the sequence of immediately consecutive frames has a more accurate basis in the first-pass bitrate. In other words, the second-pass encoding using the start QP may realize an extrapolation. If a scene-change occurs within a GOP, such an extrapolation might cause a large drift adversely affecting the rate control (RC) results. For example, to resolve such an issue, for GOPs in which a scene change is detected, the temporal subsampling may be deactivated, providing, for example, exact per-frame measurements of a fixed-QP first-pass encoding.

Aspect iii also defines a detection of a scene change. However, the start QP is determined exclusively based on the first-pass bitrate of one or more frames within the set of frames, which fall into a scene into which the respective frame falls. Since the set of frames falls into the scene into which the respective frame falls, the first-pass bitrate is determined based on a set of frames that is likely to have similar characteristics as the respective frame. Therefore, frames from a different scene, which may negatively alter the first-pass bitrate, are excluded from the set of frames. As a result, an accuracy of the second-pass encoding may be improved.

In accordance with a second main aspect of the invention, an encoder for encoding a media signal is configured to perform a first-pass encoding of a spatially sub-sampled version of the media signal using a probe QP so as to obtain first-pass bitrates for frames of the media signal, determine, based on the first-pass bitrates, start QPs for the frames of the media signal; and perform a second-pass encoding of a not spatially sub-sampled version of the media signal with using the start QPs.

It has been recognized that the spatially sub-sampled version of the media signal can have characteristics that are similar to the not spatially sub-sampled version of the medial signal that may allow the first-pass bitrate determined from the first-pass encoding can be sufficiently representative of the original version of the media signal. Therefore, the start QPs determined based on the first-pass bitrate can form an adequate basis for the second-pass encoding. The spatially sub-sampled version of the media signal has less samples than the not sub-sampled version and therefore may result in a faster first-pass encoding. As a result, a compromise between coding complexity and coding accuracy can be improved.

### BRIEF DESCRIPTION OF THE DRAWINGS

Embodiments of the present invention will be detailed subsequently referring to the appended drawings, in which:

FIG. 1 shows an example of an encoder for encoding a frame into a data stream;

FIG. 2 shows a possible implementation of encoder of FIG. 1;

FIG. 3 shows an example of an encoder for encoding a media signal;

FIG. 4 shows a schematic view of an example of a media signal;

FIG. 5 shows a schematic example of a sequence of immediately consecutive frames in form of a group of pictures with a scene change between a first scene and a second scene;

FIG. 6 shows a schematic example of a sequence of immediately consecutive frames in form of a group of pictures with a scene change comprising a transition having a plurality of frames affected by the scene change;

FIG. 7 shows an example of a sequence of immediately consecutive frames in form of a GOP, for which a coding complexity measure may be determined;

FIG. 8 shows a schematic example of an encoder for encoding a media signal;

FIG. 9 shows an exemplary diagram of start QPs determined in three different approaches;

FIG. 10 shows a close up diagram cutout of an end portion of a frame range of FIG. 9;

FIG. 11 shows an exemplary diagram of bits used for each frame in three different approaches;

FIG. 12 shows a close up diagram cutout of an end portion of a frame range of FIG. 11;

FIG. 13 shows an exemplary diagram of visual activity determined for a media stream without and with spatial sub-sampling;

FIG. 14 shows exemplary diagram of minimum motion estimation error determined for a media stream without and with spatial sub-sampling;

FIG. 15 shows a diagram of an example for deviations of average predetermined coding complexity measures relative to a reference average;

FIG. 16 shows a method for encoding a media signal; and

FIG. 17 shows a method for encoding a media signal.

### BRIEF DESCRIPTION OF THE DRAWINGS

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In order to ease the understanding of the following examples of the present application, the description starts with a presentation of possible encoders fitting thereto into which the subsequently outlined examples of the present application could be built.

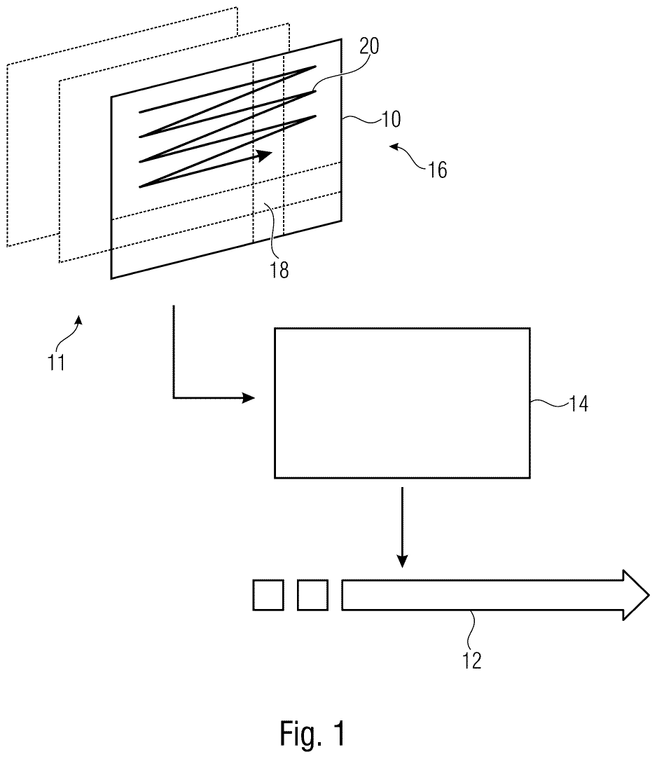

FIG. 1 shows an example of an encoder 14 for (e.g., block-wise) encoding a frame (or picture) 10 into a data stream 12. The frame 10 is part of a media signal 11. The media signal 11 may be or may comprise a video. Alternatively or additionally, the media signal 11 may be or may comprise a plurality of frames having a depth map. The media signal 11 may comprise at least one of an audio signal and a subtitle signal. The media signal 11 may comprise videos of multiple views. Frame 10 may be a current frame out of a video 16 (e.g., comprising one or more frames 10) wherein the encoder 14 is configured to encode video 16 including frame 10 into data stream 12.

The encoder 14 may be or be part of a computing device, such as a computer, one or more servers (e.g., used for cloud computing or cloud storage), a mobile phone, a tablet, a video camera, a video player, a note, a gaming console, a television, or a monitor. The encoder 14 may comprise circuitry and/or one or more processors, configured to perform any method disclosed herein (e.g., stored on a non-transitory storage medium, e.g., as a computer program product).

As mentioned above, encoder 14 may perform the encoding in a block-wise manner or block-base. To this, encoder 14 may subdivide frame 10 into blocks, units of which encoder 14 may encode frame 10 into data stream 12. Generally, the subdivision may end-up into blocks 18 of constant size such as an array of blocks arranged in rows and columns or into blocks 18 of different block sizes such as by use of a hierarchical multi-tree subdivisioning with starting the multi-tree subdivisioning from the whole picture area of frame 10 or from a pre-partitioning of frame 10 into an array of tree blocks, wherein these examples shall not be treated as excluding other possible ways of subdivisioning frame 10 into blocks 18. The blocks may have a square shape (e.g., 4×4, 8×8, 16×16, or 32×32 pixels) and/or a rectangular shape (e.g., 4×8, 8×16, or any other ratio between height and width).

Further, encoder 14 may be a predictive encoder configured to predictively encode frame 10 into the data stream 12. For a certain block 18 this means that the encoder 14 may determine a prediction signal (or data or bit string) for block 18 and encodes the prediction residual, i.e. the prediction error at which the prediction signal deviates from the actual frame content (e.g., in a spatial or frequency domain) within block 18, into data stream 12.

Encoder 14 may support different prediction modes so as to derive the prediction signal for a certain block 18. The prediction modes may comprise intra-prediction modes according to which the inner of block 18 is predicted spatially from neighboring, already encoded samples of frame 10. The encoding of frame 10 into data stream 12 and, accordingly, the corresponding decoding procedure, may be based on a certain coding order 20 defined among blocks 18. For instance, the coding order 20 may traverse blocks 18 in a raster scan order such as row-wise from top to bottom with traversing each row from left to right, for instance. In case of hierarchical multi-tree based subdivisioning, raster scan ordering may be applied within each hierarchy level, wherein a depth-first traversal order may be applied, i.e. leaf notes within a block of a certain hierarchy level may precede blocks of the same hierarchy level having the same parent block according to coding order 20. Depending on the coding order 20, neighbouring, already encoded samples of a block 18 may be located usually at one or more sides of block 18. For instance, neighbouring, already encoded samples of a block 18 are located to the top of, and to the left of block 18.

Intra-prediction modes may not be the only ones supported by encoder 14. The encoder 14 may also support intra-prediction modes according to which a block 18 is temporarily predicted from a previously encoded frame of video 16 (e.g., inter-prediction mode). Such an intra-prediction mode may be a motion-compensated prediction mode according to which a motion vector is signalled for such a block 18 indicating a relative spatial offset of the portion from which the prediction signal of block 18 is to be derived as a copy. Additionally or alternatively, other non-intra-prediction modes may be available as well such as inter-view prediction modes in case of encoder 14 being a multi-view encoder, or non-predictive modes according to which the inner of block 18 is coded as is, i.e. without any prediction. Additionally or alternatively, the encoder 14 may be configured to perform inter-layer prediction, e.g., if the encoder 14 supports scalable video coding, e.g., for coding multiple layers with different video quality and/or resolution.

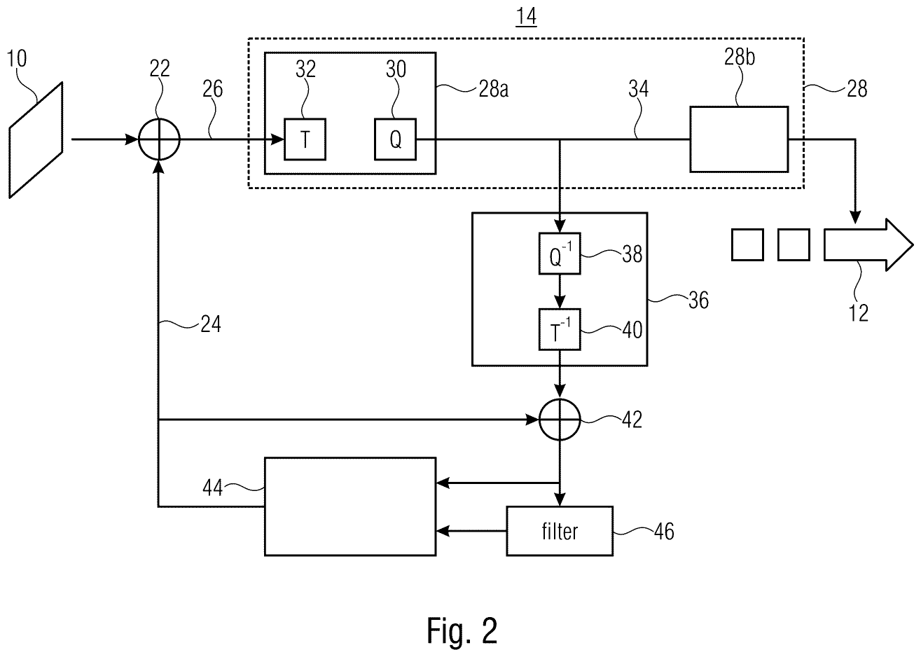

FIG. 2 shows a possible implementation of encoder 14 of FIG. 1, namely one where the encoder 14 is configured to use transform coding for encoding the prediction residual although this is nearly an example and the present application is not restricted to that sort of prediction residual coding. According to FIG. 2, encoder 14 may comprise a subtractor 22 configured to subtract from the inbound signal, i.e. frame 10 or, on a block basis, current block 18, the corresponding prediction signal 24 so as to obtain the prediction residual signal 26 which is then encoded by a prediction residual encoder 28 into a data stream 12. The prediction residual encoder 28 may be composed of a lossy encoding stage 28a and a lossless encoding stage 28b. However, the encoding stage 28a may be lossless and/or the encoding stage 28b may be lossy. The lossy stage 28a may receive the prediction residual signal 26 and may comprise a quantizer 30 which quantizes the samples of the prediction residual signal 26. As already mentioned above, the present example may use transform coding of the prediction residual signal 26 and accordingly, the lossy encoding stage 28a may comprise a transform stage 32 connected between subtractor 22 and quantizer 30 so as to transform such a spectrally decomposed prediction residual 26 with a quantization of quantizer 30 taking place on the transformed coefficients where presenting the residual signal 26. The transform may be a DCT, DST, FFT, Hadamard transform or the like. The transformed and quantized prediction residual signal 34 may then be subject to lossless coding by the lossless encoding stage 28b which may be an entropy coder (e.g., Huffman coding or arithmetic coding) entropy coding quantized prediction residual signal 34 into data stream 12. Encoder 14 may further comprise the prediction residual signal reconstruction stage 36 connected to the output of quantizer 30 so as to reconstruct from the transformed and quantized prediction residual signal 34 the prediction residual signal in a manner also available at a decoder, i.e. taking the coding loss is quantizer 30 into account. To this end, the prediction residual reconstruction stage 36 may comprise a dequantizer 38 which perform the inverse of the quantization of quantizer 30, followed by an inverse transformer 40 which may perform the inverse transformation relative to the transformation performed by transformer 32 such as the inverse of the spectral decomposition such as the inverse to any of the above-mentioned specific transformation examples. Encoder 14 may comprise an adder 42 which adds the reconstructed prediction residual signal as output by inverse transformer 40 and the prediction signal 24 so as to output a reconstructed signal, i.e. reconstructed samples. This output may be fed into a predictor 44 of encoder 14 which then determines the prediction signal 24 based thereon. It is predictor 44 which may support all the prediction modes already discussed above with respect to FIG. 1. FIG. 2 also illustrates that in case of encoder 14 being a video encoder, encoder 14 may also comprise an in-loop filter 46 with filters completely reconstructed pictures which, after having been filtered, form reference pictures for predictor 44 with respect to inter-predicted block.

It is noted that the encoder 14 is only an example for an encoder which may be compatible with the principles disclosed herein. The encoder 14 may comprise less features, alternative features, and/or additional features. The encoder 14 (or any alternative thereof) may, for example, be configured to perform any method disclosed herein. The encoder 14 may be combined with any apparatus disclosed herein. In such a case, the encoder 14 and the apparatus may be configured to communicate one or more parameters.

### Description of Embodiment of the Invention:

To reduce the runtime in rate control (RC) applications that process pictures in a complete first pass or using a look-ahead window, a sub-sampling of the first pass of RC is proposed.

The sub-sampling can be performed in (one or both of) two domains, which can also be combined: temporal sub-sampling and spatial sub-sampling. In the following, temporal sub-sampling will be described first and spatial sub-sampling afterwards. However, it is noted that the two sub-sampling approaches are not exclusive to each other and can be combined in their respective entirety or only aspects of each sub-sampling aspect can be combined with aspects of the other sub-sampling aspect.

### Temporal Sub-Sampling

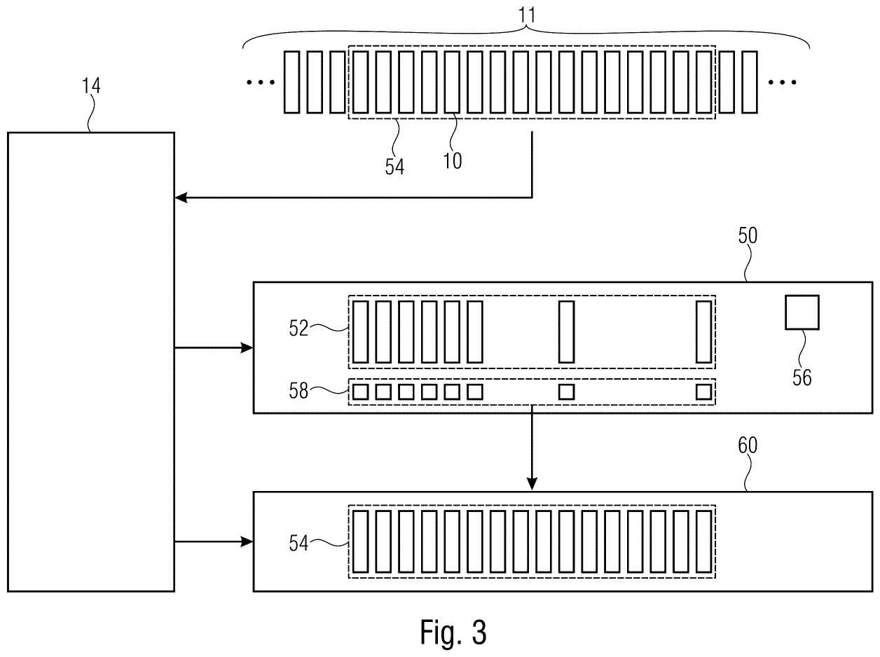

FIG. 3 shows an example of an encoder 14 for encoding a media signal 11. The encoder 14 is configured to perform a first-pass 50 encoding of the media signal 11 (e.g., comprising or being a video) with restricting the first-pass encoding onto a set 52 of frames 10 out of a sequence 54 of immediately consecutive frames (e.g. immediately consecutive in terms of coding order with, for instance, forming a contiguous temporal section of the media signal 11) of the media signal 11 and using a probe quantization parameter (QP) 56 for each of the set 52 of frames 10 of the media signal 11, so as to obtain a first-pass bitrate 58 for each of the set 52 of frames 10.

The encoder 14 is further configured to determine, based on the first-pass bitrate for each of the set 52 of frames 10, a start QP 58 for each of the sequence 54 of immediately consecutive frames 10.

The encoder 14 is configured to perform a second-pass encoding 60 of the media signal 11 with using the start QP 58 for each of the sequence 54 of immediately consecutive frames 10.

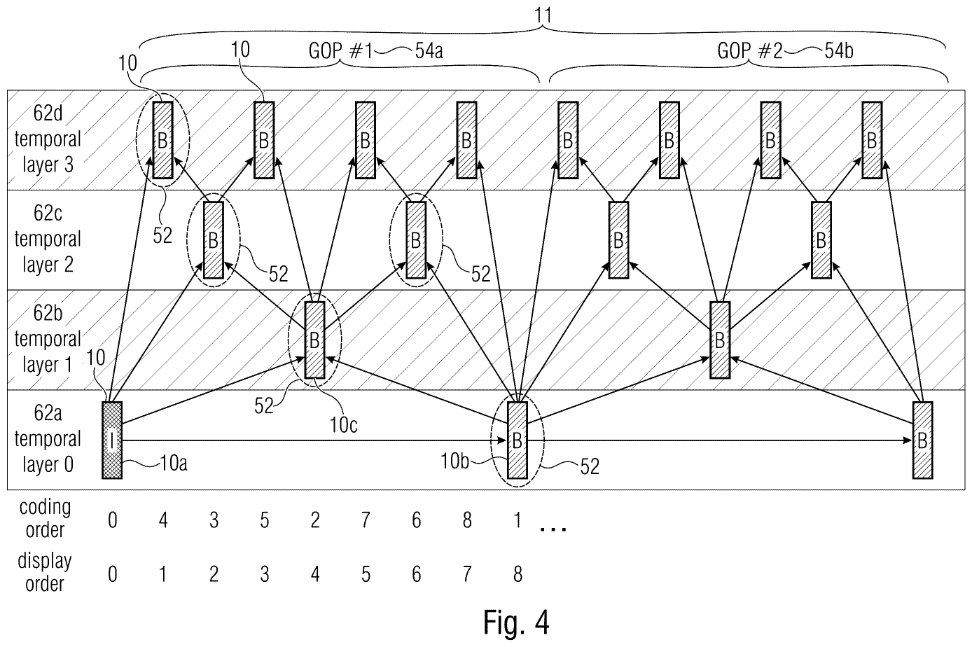

FIG. 4 shows a schematic view of an example of a media signal 11. The media signal 11 comprises two sequences 54a, b of immediately consecutive frames 10. However, the media signal 11 may comprise any other number of sequences 54 (e.g., one, three, or more sequences 54). A sequence 54 of consecutive frames 10 may be a group of pictures (e.g., collection of successive pictures or frames 10 within a coded video stream; e.g., in a consecutive coding order, e.g., in a consecutive display order). FIG. 4 shows an example of a media signal 11 with four temporal layers 62a-d. However, the media signal 11 may not have a structure with temporal layers or may have a different structure of temporal layers (e.g., a different number of temporal layers 62, e.g., three, five, six, or more temporal layers 62). The example in FIG. 4 shows a group of pictures (or Group-Of-Pictures) with eight pictures or frames 10. However, the sequence 54 of immediately consecutive frames 10 may have a different structure (e.g., other than a group of pictures) and/or a different number of frames (e.g., two, three, four, or more frames, e.g., 16, 32 or 64 frames, e.g., an amount of frames different from a power of two).

The sequence 54 of immediately consecutive frames 10 may have a coding order for frames 10 (e.g., an order in which the frames 10 are to be coded in the media signal 11) and a display coding for frames (e.g., a temporal order in which 10 frames are consecutively displayed in a video). The coding order and the display order of the frames may be different. The coding order may depend on or be represented by temporal layers. For example, frames 10 in a low temporal order (e.g., temporal layer 0 or 62a) may be coded before frames 10 in a higher temporal order (e.g., temporal layer 3 or 62d). As a result, frames 10 that are in a higher temporal layer 62 may reference (e.g., for prediction, e.g., for inter-frame prediction) frames 10 from a lower temporal layer 62.

The media signal 11 shown in FIG. 4, comprises in temporal layer 0 or 62a an intra coded frame 10a (or I-frame, labelled “I” in FIG. 4) and a bidirectionally predictive-coded frame 10b (or B-frame, labelled “B” in FIG. 4) connected by arrow. The arrow indicates that the B-frame 10b of temporal layer 0 may be referencing (e.g., for inter-frame prediction) the I frame 10a of the same temporal layer 0. The temporal layer 1 or 62b in FIG. 4 comprises a B-frame 10c that references the I-frame 10a and B-frame 10b of temporal layer 0 and is therefore coded after (e.g., in coding order) the B-frame 10b of temporal layer 0. However, in display order, the B-frame 10b of temporal layer 1 is arranged before the B-frame of temporal layer 1 (e.g., is shown earlier in a video playback). Therefore, the B-frames of temporal layers 0 and 1 (e.g., as well as the other temporal layers 62) have different orders for coding and displaying. An advantage of such a coding order is that decoding of frames 10 of higher temporal layers can be omitted (e.g., due to a limited transmission bandwidth or a transmission error) without significantly impacting decoding of frames 10 of lower temporal layers, as the lower temporal level frames 10 may not reference higher temporal level frames 10. Therefore, decoding stability may be increased.

It is noted that the I-frame 10a in FIG. 4 is not part of a first sequence 54a of immediately consecutive frames 10 (or GOP #1). Alternatively, the I-frame 10a (or any other I-frame) may be part of a sequence 54 of immediately consecutive frames 10. Furthermore, a of a sequence 54 of immediately consecutive frames 10 is not required to follow an I-frame. As can be seen in FIG. 4, a second sequence 54b of immediately consecutive frames 10 (or GOP #2) follows the B-frame 10b of the first sequence 54a of immediately consecutive frames 10.

Furthermore is provided at least one aspect of the following aspects i to iii:
i) the sequence 54 of immediately consecutive frames is a group of pictures (GOP; e.g. GOP #1 in FIG. 4) having a hierarchical referencing structure with temporal layers including a temporal base layer 0 (e.g. a temporal layer 0 inevitably to be decoded; e.g. TLO in FIG. 4) up to a highest temporal layer N-1 (e.g. and temporal layers 0<n<N the decoding which necessitates a previous decoding of temporal layers m<n; e.g. TL3 in FIG. 4) and the encoder 14 is configured to select the set 52 of frames (e.g. those encircled among the eight ones of GOP #1 in FIG. 4) out of the sequence 54 of immediately consecutive frames so that the set 52 of frames includes all frames of temporal layers 0 to k-1, and, for each temporal layer k to N-1, only a proper subset of the frames of the sequence of immediately consecutive frames which belong to the respective temporal layer, wherein 1<k<N (e.g. 2<k<N) (e.g. k=3 in FIG. 4), and
ii) the encoder 14 is configured to perform scene detection to detect scene changes, and select the set 52 of frames 10 out of the sequence 54 of immediately consecutive frames 10 depending on whether any of the scene changes falls into the sequence 54 of immediately consecutive frames 10 so that the set 52 of frames represents a sequentially sub-sampled subset (e.g. those encircled out of GOP #1 in FIG. 4) of a sequence of immediately consecutive frames of the media signal 11 in case of none of the scene changes falling into the sequence of immediately consecutive frames 54, and
iii) the encoder 14 is configured to perform scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls.

Only one of the aspects i to iii may be provided or a combination thereof (e.g., i and ii, ii and iii, i and iii, or i, ii, and iii).

The first-pass encoding 50 may involve an encoder-search space which is reduced compared to the second-pass encoding 60. For example, an interval for block sizes may be restricted or reduced (e.g., to block sizes of 4×4, 8×8, and 16×16 pixels) in the first pass 50 compared to the second pass 60. Alternatively or additionally, the encoder-search space may be limited to a certain frames 10 (e.g., of only a immediately preceding frames or frames of lowest temporal layer). As a result, encoding complexity may be reduced.

The first-pass encoding 50 may operate using rate-distortion optimization at variable rate and the second-pass encoding 60 may operate using rate-distortion optimization in a rate-controlled manner. A variable rate (e.g., a bit rate in units of bits per second) may comprise the use of a fixed quantization parameter (e.g., the probe QP 56 or fixed range of probe QPs 56) for different frames 10 resulting in variable bitrates. A rate-controlled manner may comprise the use of variable QP for different frames 10 (e.g., the start QPs 58) in order to realize or approach (e.g., within a certain range) a target bitrate.

Therefore, the rate-distortion may be adjustable to the probe QP 56 for the first-pass encoding 50 and adjustable to the start QP 58 for the second-pass encoding 60.

The encoder 14 may be configured to perform the first-pass encoding 50 onto consecutive sequences 54 of immediately consecutive frames 10 of the media signal 11 before performing the second-pass encoding 60 onto each of the consecutive sequences 54 of immediately consecutive frames 10. For example, the media signal 11 may comprise a video with a total amount of frames 10 (e.g., a total duration), wherein the first-pass encoding 50 is performed for the entire amount of frames 10 (e.g., total duration) before performing the second-pass encoding 60.

Alternatively, encoder 14 may be configured to perform the first-pass encoding 50 and the second-pass encoding 60 onto consecutive sequences 54 of immediately consecutive frames 10 of the media signal 11 in an interleaved manner. For example, the encoder 14 may be configured to alternate between performing first-pass encoding 50 and second-pass encoding 60 (e.g., of the same portion or a different portion of the media stream 11). For example, the encoder 14 may be configured to perform the first-pass encoding 50 of a first portion of the media signal 11 and then perform the second-pass encoding 60 of the first portion of the media signal 11. During or after performing the second-pass encoding 60 of the first portion, the encoder may be configured to perform first-pass encoding 50 of a second portion of the media signal 11. The encoder 14 may be configured to perform the first and/or second encoding 50, 60 using a sliding window (or a sliding window for the first-pass and second-pass encoding 50, 60, respectively) or a look-ahead window over the media signal 11.

The encoder 14 may be configured to determine, based on the first-pass bitrate for each of the set 52 of frames, the start QP 58 for each of the sequence 54 of immediately consecutive frames 10 by determining, for each frame 10 of the sequence 54 of immediately consecutive frames 10, which is not comprised by the set 52 of frames 10, a first-pass bitrate based on the first-pass bitrate for each of the set 52 of frames 10, and determining, for each frame 10 of the sequence 54 of immediately consecutive frames, the start QP 58 based on the first-pass bitrate of the respective frame. For example, the encoder 14 may be configured to determine the first-pass bitrate of each frame 10 of the sequence 54 of immediately consecutive frames 10, which is not comprised by the set 52 of frames 10, as an average (e.g., arithmetic or geometric) of the first-pass bitrate determined for all or a part of the frames 10 of the set 52 of frames 10. In another example, the encoder 14 may be configured to determine the first-pass bitrate of each frame 10 of the sequence 54 of immediately consecutive frames 10, which is not comprised by the set 52 of frames 10, to be a first-pass bitrate (e.g. or a modified version thereof, e.g., a rescaled version thereof) determined of a frame 10 that is included in the set 52 of frames 10.

The encoder 14 may be configured to determine, for each frame 10 of the sequence 54 of immediately consecutive frames 10, which is not comprised by the set 52 of frames, the first-pass bitrate based on the first-pass bitrate for each of the set 52 of frames 10 by selecting one or more frames 10 out of the set 52 of frames having a temporal layer associated therewith which equals the temporal layer of the respective frame. For example, the decoder 14 may be configured to determine the first-pass bitrate for frames 10 not comprised by the set 52 of frames to be equal to or a modified version of a frame 10 (or an average or median out of multiple frames 10) out of the set of 52 of frames 52 having the same temporal layer.

For example, in FIG. 4, GOP #1 has four frames 10 in temporal layer 3 or 62d. The encoder may be configured to determine a first-pass bitrate for the left-most or first frame (in FIG. 4 the only frame 10 temporal layer 3 that has a circle) and may determine the first-pass bitrate of the other three frames 10 of the temporal layer 3 to be the same first-pass bitrate as determined for the first frame 10 of the temporal layer 3.

The start QP 58 of the frames of the set 52 of frames 10 may be determined based on a target bitrate (e.g., of the sequence 54 of immediately consecutive frames 10), the probe QP 56, and the first-pass bitrate. For example, if the first-pass bitrate is larger than the target bitrate, the start QP 58 of a frame 10 may be determined as an larger version (e.g., upscaled version) of the probe QP 56 and vice versa as a smaller version (e.g., downscaled version) for a first-pass bitrate that is smaller than the target bit rate.

In the example above, the encoder 14 is configured to determine the first-pass bitrate of frames 10 not comprised by set 52 of frames 10 based on the first-pass bitrate of frames of the set 52 of frames 10. Alternatively or additionally, the encoder 14 may be configured to determine the start QP 58 of the frames 10 not comprised by set 52 of frames 10 based on the start QP 58 of frames of the set 52 of frames 10.

The number of temporal layers N may be 6 (e.g., with temporal layers 0 to 5) or 5 (e.g., with temporal layers 0 to 4). The temporal layer k, for which only a proper subset of the frames of the sequence of immediately consecutive frames belongs to the respective temporal layer may be three.

The term “proper” in “proper subset” herein is to be understood in the mathematical sense. In other words, the sequence of immediately consecutive frames is not identical to the proper subset of the frames, but contains at least one frame that is not contained in the subset of the frames. In other words, the subset of the frames is smaller than the sequence of immediately consecutive frames.

The number of temporal layers N may be 6 with k=4 and a size of the sequence 54 of immediately consecutive frames (or GOP) may be 32 frames. In a different example, the number of temporal layers N may be 5 with k=3 and a size of the sequence of immediately consecutive frames (or GOP) may be 16 frames. The encoder 14 may be configured to select a size of the GOP based on the number of temporal layers or vice versa. It is noted that any other number of layers may be combined with any other size of the sequence 54 of immediately consecutive frames (or GOP) and/or any other value for k.

According to an embodiment, the sequence of immediately consecutive frames may be a group of pictures (GOP) having a hierarchical referencing structure with temporal layers 62 including a temporal base layer 0 up to a highest temporal layer N-1 and the encoder 14 may be configured to select the set 52 of frames 10 out of the sequence 54 of immediately consecutive frames 10 so that the set 52 of frames 10 includes all frames 10 of temporal layers 0 to k-1, and, for each temporal layer k to N-1, only a proper subset of the frames 10 of the sequence 54 of immediately consecutive frames 10 which belong to the respective temporal layer 62. The encoder 14 may be configured to perform scene detection to detect scene changes, and select k and/or select the proper subset for each of the temporal layers k to N-1 depending on whether any of the scene changes falls into the GOP.

For example, the encoder 14 may be configured to select k=N-1 if any of the scene changes falls into the GOP, and set k so that 1<k<N (e.g., 2<k<N) if none of the scene changes falls into the GOP. In other words, if a scene change falls into the GOP, the encoder 14 may be configured to select the proper subset for only the highest temporal layer k=N-1, but for a different temporal layer (e.g., k=3) if no scene change falls into the GOP. Alternatively, if a scene change falls into the GOP, no proper subset may be selected for any temporal layer (e.g., temporal sub-sampling may be switched off for such GOPs). If the scene change falls into the GOP, the value of k may be dependent on a position of the scene change within the GOP. For example, a larger value for k may be selected for an early scene change within the GOP compared to a smaller value for k for a late scene change within the GOP.

The encoder 14 may be configured to determine scene changes based on a change of at least one of detected edges, measure of inter-prediction, and sample value distribution of the frame 10.

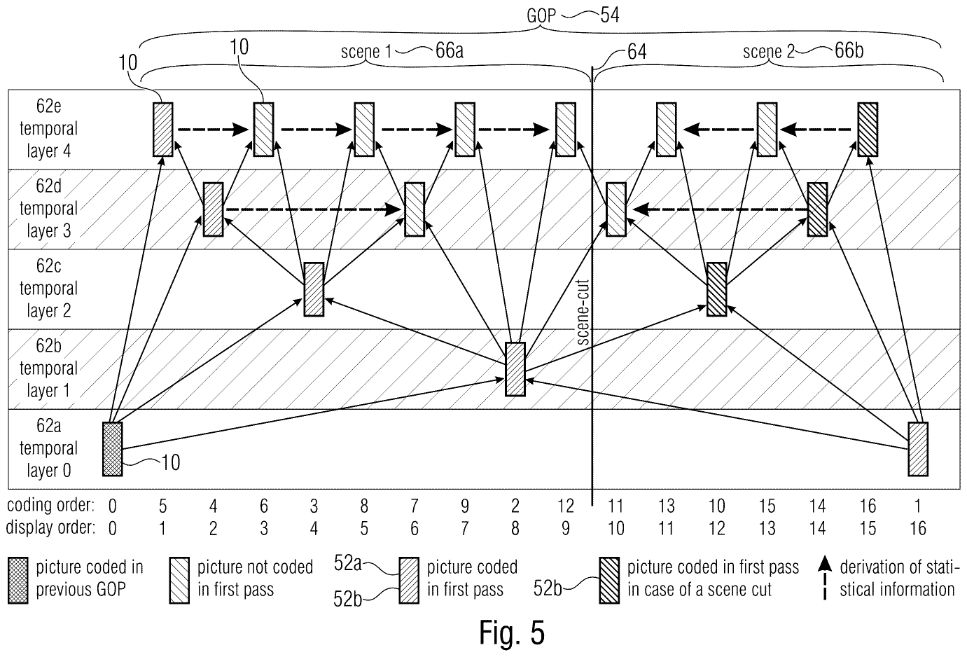

FIG. 5 shows a schematic example of a sequence 54 of immediately consecutive frames 10 in form of a group of pictures (GOP) with a scene change 64 between a first scene 66a and a second scene 66b. In other words, FIG. 5 shows a first pass (e.g., indicating which frames 10 are encoded in a first pass) with a SceneCut (e.g., a scene change 64 with no transition frames 10, e.g., with not transition frames 10 between a first and second scene 66a, b). The group of pictures in FIG. 5 exemplarily comprises five temporal layers 0 to 4 (e.g., N=5). The scene change 64 comprises a scene cut, wherein the scene changes without transition from one frame to another (e.g., in FIG. 5 from a frame 10 at display order position 9 to a frame at display order position 10). A scene cut may occur, for example, when a viewpoint of a scene is changed (e.g., to a different camera), a segment of a video is cut out, or a video is interrupted by an advertisement.

In a first example of FIG. 5, no scene change is detected. In other words, from display order 0 to 16, no scene change is detected. In such a case, the encoder 14 may be configured to select, for example, the set of frames 52a (in FIG. 5 indicated as frames with a checkered pattern) out of the sequence 54 of immediately consecutive frames 10 so that the set 52 of frames 10 includes all frames 10 of temporal layers 0 to 1 (e.g., with k=2), and, for each temporal layer 2 to 4, only a proper subset of the frames 10 of the sequence 54 of immediately consecutive frames 10 which belong to the respective temporal layer 62 is selected. Therefore, in the example shown in FIG. 5, for each temporal layer 62, one frame 10 is coded in case of no detected scene change. However, any other sequence 54 of immediately consecutive frames 10, value for k, number of temporal layers 62, and hierarchical structure may be used.

In a different example of FIG. 5, a scene change 64 is detected between frames 9 and 10 of the display order.

According to an embodiment, the sequence 54 of immediately consecutive frames 10 may be a group of pictures (GOP) having a hierarchical referencing structure with temporal layers 62 including a temporal base layer 0 up to a highest temporal layer N-1 and the encoder 14 may be configured to select the set 52 of frames 10 out of the sequence 54 of immediately consecutive frames 10 so that the set 52 of frames 10 includes all frames 10 of temporal layers 0 to k-1, and, for each temporal layer k to N-1, only a proper subset of the frames of the sequence 54 of immediately consecutive frames 10 which belong to the respective temporal layer 62, and the encoder 14 is configured to perform scene detection to detect scene changes, and select k and/or select the proper subset for each of the temporal layers k to N-1 depending on which frame 10 within the GOP any of the scene changes coincides with.

For example, the encoder 14 may be configured to select k and/or select the proper subset for each of the temporal layers k to N-1 so that the set 52 (or set 52b in FIG. 5) of frames 10 comprises, for each of the temporal layers 62, at least one (e.g., exactly one) frame 10 of the respective temporal layer 62 which is within a scene 66a preceding the scene change in the GOP, and at least one (e.g., exactly one) frame 10 of the respective temporal layer 62 which is within a scene 66b extending from the scene change 64 onwards in the GOP 54.

In FIG. 5, an exemplary set 52b of frames 10 is indicated as a combination of checkered and striped frame icons. From temporal layers 0 to 2, all frames 10 are selected for the set 52b of frames 10. However, for temporal layers 3 and 4 proper subsets for each of the temporal layer 62 are selected. In temporal layer 3 (or 62d), one frame 10 (at display order position 2) is selected in the first scene 66a and one frame 10 (at display order position 14) is selected in the second scene 66b. In temporal layer 4 (or 62e), one frame 10 (at display order position 1) is selected in the first scene 66a and one frame 10 (at display order position 15) is selected in the second scene 66b. However, the set 52b of frames 10 may be selected differently. For example, proper subsets may be selected only in temporal layer 4 (i.e. the set 52b of frames 10 may comprise all frames of temporal layer 3, but not all frames 10 of temporal layer 4). Furthermore, more than one frame 10 (e.g., two, three, or more) frames 10 may be selected in a scene 66a, b (or both scenes) of a temporal layer 62, in which a proper subset is selected.

By selecting frames 10 from both scenes 66a, b for the set 52 of frames 10, for determining the first-pass bitrate of a frame 10 that is not comprised by the set 52, a frame 10 of the same scene (instead of the other scene) may be available as a basis. Therefore, encoding accuracy may be increased.

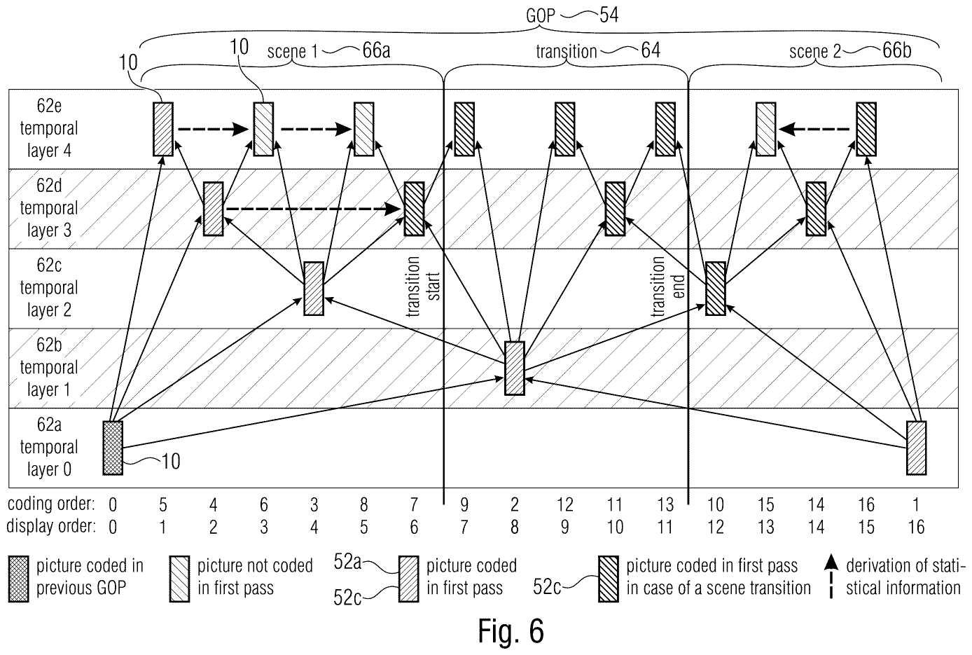

FIG. 6 shows a schematic example of a sequence 54 of immediately consecutive frames 10 in form of a group of pictures (GOP) with a scene change 64 comprising a transition having a plurality of frames 10 affected by the scene change 64. In other words, FIG. 6 shows a first pass (e.g., indicating which frames are first-pass encoded) with a scene transition (e.g., frames 10 that are not entirely part of a single scene, e.g., because of fading to another scene or a different image). The scene change 64 exemplarily extends from a frame 10 at display order position 7 to a frame at display order position 11.

The scene change 64 may comprise, for example, fading to an empty image (e.g., black or white picture) or a dissolve, wipe, iris, or whip pan between the first and second scene 66a, b, a.

The encoder 14 may be configured to select k and/or select the proper subset for each of the temporal layers k to N-1 so that the set 52 of frames 10 comprises all of one or more frames 10 affected by the scene change 64 and all frames referenced, by way of inter-frame prediction, by the one or more frames affected by the scene change 64. In FIG. 6, references are indicated by arrows pointing from a referenced frame 10 to a referencing frame 10. By including the referenced frames in the set 52, encoding efficiency and stability may be increased.

In the example shown in FIG. 6, the set 52c comprises all frames 10 in the transition of the scene change 64 (e.g., from display order position 7 to 11). Alternatively, some frames (e.g., of the highest temporal layer 62) may not be part of the set 52c. The scene change 64 of a transition can involve a significant change of sample values in the pixels. By selecting all frames 10 affected by the scene change, the first-pass bitrate for each of the set 52c of frames 10 may be better representative for all frames 10 of the sequence 54 of immediately consecutive frames 10.

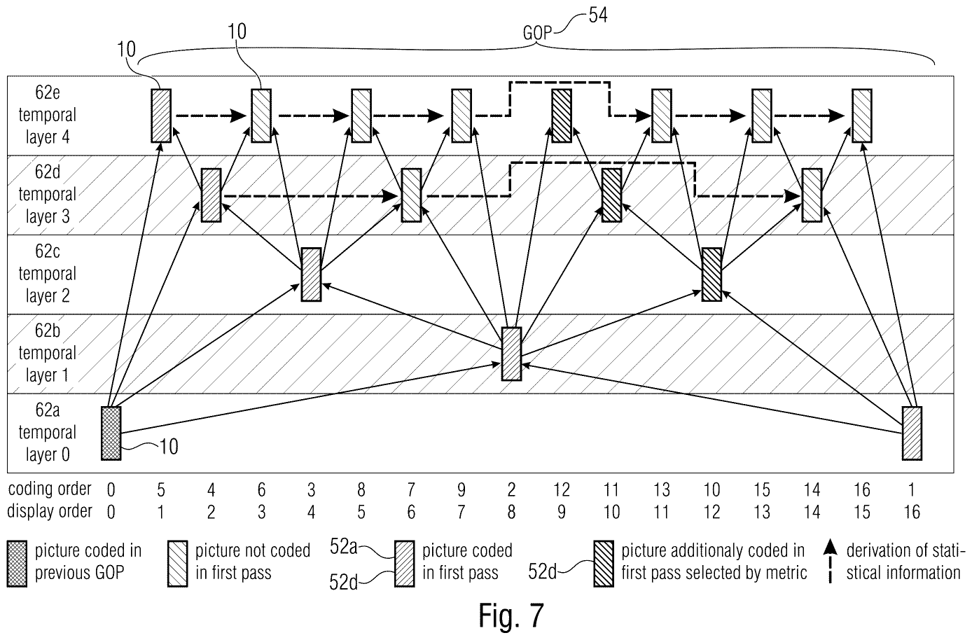

FIG. 7 shows an example of a sequence 54 of immediately consecutive frames 10 in form of a GOP, for which a coding complexity measure may be determined. In other words, FIG. 7 shows a first pass (e.g., indicating which frames 10 are first-pass encoded) with inserted coded pictures (e.g., frames 10 that first first-pass encoded due to fulfilling a predetermined criterion).

In a first example of FIG. 7, no coding complexity measure is determined. In such a case, the encoder 14 may be configured to select, for example, the set of frames 52a (in FIG. 7 indicated as frames with a checkered pattern) out of the sequence 54 of immediately consecutive frames 10 so that the set 52 of frames 10 includes all frames 10 of temporal layers 0 to 1 (e.g., with k=2), and, for each temporal layer 2 to 4, only a proper subset of the frames 10 of the sequence 54 of immediately consecutive frames 10 which belong to the respective temporal layer 62 is selected. Therefore, in the example shown in FIG. 7, for each temporal layer 62, one frame 10 is encoded. However, any other sequence 54 of immediately consecutive frames 10, value for k, number of temporal layers 62, and hierarchical structure may be used. The first example of FIG. 7 corresponds essentially to the first example of FIG. 5, in which no scene change is detected.

In a second example of FIG. 7, a coding complexity measure may be determined for each frame 10 of the sequence 54 of immediately consecutive frames 10.

According to an embodiment, the encoder 14 may be configured to determine one or more coding complexity measures for each of the frames 10 of the sequence 54 of immediately consecutive frames 10. In the example shown in FIG. 7, the sequence 54 of immediately consecutive frames 10 comprises 16 frames, wherein for each of the 16 frames is determined one or more coding complexity measures. Alternatively, the sequence 54 of immediately consecutive frames 10 may comprise a different amount of frames 10.

The coding complexity measure (e.g., a pre-calculated metric) may be indicative of at least one of an amount of time, amount of processing resources, and data amount for coding a frame 10. The coding complexity may be determined based on an activity measure and/or a minimum motion estimation error (MMEE) of the frame 10. For example, the coding complexity measure may be determined based on (or as) a visual activity (or spatial activity) of a frame 10. The coding complexity measure may be determined based on (or as) one or more of a visual activity, a mean value, a gradient and histogram data of one or more color planes (e.g., of versions of a frame 10 that comprise only one color channel, e.g., a frame representation of only a red, blue and green color). Alternatively or additionally, the coding complexity measure may be determined based on (or as) sample-wise differences between consecutive original pictures or consecutive motion compensated pictures.

The coding complexity measure may be determined based an average and/or standard deviation of sample values of the frame 10 (or blocks thereof). The coding complexity measure may be determined based on a difference or standard deviation between neighboring sample values of the frame 10. The coding complexity measure of a frame may define a plurality of values. The plurality of values of a frame 10 may be determined based on a plurality of regions (e.g., coding blocks) of the frame 10 and/or of a plurality of complexity measure types (e.g., more than one of visual activity, a mean value, a gradient and histogram data of one or more color planes).

The coding complexity measure of a frame i may be determined based on (or as) SpatialActivityᵢ as used (or defined) in the Fraunhofer Versatile Video Encoder (VVenC) and/or as a (minimum) motion estimation error MMEEᵢ, e.g., obtained during motion compensated temporal filtering (MCTF). The coding complexity measure of a frame i may be denoted herein as Vᵢ.

The coding complexity measure of a frame may be defined by a single scalar. The single scalar may be determined based on a single complexity measure type or may be a combination (e.g., one or more of a sum, a weighted sum, a ration, and a product) of values of multiple complexity measure types.

The decoder 14 may further be configured to select k and/or select the proper subset for each of the temporal layers k to N-1 so that the set 52 of frames comprises all of one or more frames 10 whose one or more coding complexity measures fulfill a predetermined criterion (e.g. differs by more than a predetermined threshold from an average of) with respect to the one or more coding complexity measures of a reference set of frames 10 including one or more of, all of, or all of remaining frames 10 of the sequence 54 of immediately consecutive frames 10, or one or more, or all of frames of one or more preceding sequences of immediately consecutive frames.

In the example shown in FIG. 7, the reference set of frames 10 may, for example, be formed by all 16 frames of the sequence 54 of immediately consecutive frames 10. The reference set of frames 10 may be formed by all frames 10 or all previous frames 10 of the media sample 11. In a different example, the reference set of frames 10 may be a subset of the sequence 54 of immediately consecutive frames 10 such as the lowest one, two, three, or four temporal layers 62 (i.e., a total of one, two, four, or eight frames).

In another example, the reference set of frames 10 may include all frames that would have not been included in the first-pass encoding 50, if no coding complexity measures determined. In the first example described above for FIG. 7, in which no coding complexity measure is determined, four frames would be included in the first-pass encoding (e.g., frames 10 with a checkered pattern, e.g., frames 10 at the display order positions 1, 2, 4, and 16). Therefore, frames 10 with no pattern or with striped pattern would not be included the set of frames 52a (e.g., frames 10 at display order positions 3, 5, 6, 7, 9, 10, 11, 13, 14, and 15), which may form the reference set of frames 10.

Alternatively or additionally, frames 10 of one or more (directly and/or indirectly) preceding sequences 54 of immediately consecutive frames 10 may be part of the reference set of frames 10. The frames 10 of the one or more preceding sequences 54 of immediately consecutive frames 10 may be selected in the same way or differently as described above for the (current) sequence 54 of immediately consecutive frames 10.

The predetermined criterion may define a threshold for a deviation of a frame 10 from a central measure of the coding complexity measures of a reference set of frames 10. For example, the central measure of the coding complexity measure may be an average (e.g., arithmetic mean or geometric mean) or median of coding complexity measures of the reference set of frames. For example, for each frame 10 of the reference set of frames may be determined a coding complexity measure based on (or as) visual activity (or any other type of coding complexity measure disclosed above) and the central measure of the coding complexity measure may be determined based on (or as) an average or median of the determined coding complexity measures of each frame 10 of the reference set of frames.

For example, the central measure may be determined using an arithmetic mean V_{mean, ref} Of coding complexity measures of the reference set of frames (e.g., the GOP). The arithmetic mean V_{mean, ref} of coding complexity measures of the reference set of frames may be defined as a

$${V}_{mean , ref} = \frac{{\sum }_{i} {V}_{i}}{{N}_{ref}} \qquad ( equation 1 )$$

with a frame index i of a total amount of N_{ref} frames of the reference set of frames. The deviation of a frame 10 may be determined based on (or as) a difference of the coding complexity measure of said frame relative to the central measure. For example, a deviation d_{i,ref} of a frame i may be determined using the following equation:

$${d}_{i , ref} = \vert {V}_{i} - {V}_{mean , ref} \vert \qquad ( equation 2 )$$

The predetermined criterion may comprise a threshold for the deviation, e.g., for d_{i,ref}. For example, the encoder 14 may be configured to select k and/or select the proper subset for each of the temporal layers k to N-1 so that the set 52 (or 52d in FIG. 7) of frames comprises all of one or more frames 10, whose deviation d_{i,ref} exceeds a threshold.

In the example shown in FIG. 7, the encoder 14 may determine that frames 10 at display order positions 9, 10 and 12 (indicated in FIG. 7 as frames with a striped pattern) fulfill the predetermined criterion (e.g., having a deviation d_{i,ref} exceeding a threshold) and include said frames in the set 52d of frames 10.

The decoder 14 may be configured to determine the probe QP 56 for each of the set 52 of frames based on the one or more coding complexity measures determined for the respective frame 10. For example, the decoder 14 may be configured to determine a smaller probe QP 56 for frames with a larger coding complexity measure (e.g., indicating a larger complexity for coding) compared to a larger probe QP 56 for frames with a smaller coding complexity measure (e.g., indicating a smaller complexity for coding). The encoder 14 may be configured to determine a probe QP 56 that decreases (e.g., monotonically, e.g., according to a step function) with the coding complexity measure. For example, the encoder 14 may be configured to determine a probe QP 56 that decreases (e.g., monotonically, e.g., according to a step function) with the deviation d_{i,ref}.

By selecting the set 52 of frames based on the one or more coding complexity measures, frames 10 that differ significantly from other frames of the sequence 54 of immediately consecutive frames 10 are less likely to be excluded from the set 52. As a result, the first-pass bitrate is more representative of the frames 10 of the sequence 54 of immediately consecutive frames 10 and can provide a more accurate base for determining the start QP 58.

In other words, independent from the scene-change use case, to capture temporarily effects within one scene (e.g. flash lights, e.g., see FIG. 7), it is proposed for a temporal down-sampled first pass (e.g., similar as described above with switching off the temporal sub-sampling or during scene transition), injecting coded pictures (e.g., frames 10 at display order positions 9 and 10 in FIG. 7), e.g., as well as their un-coded references pictures (e.g., frame 10 at display order position 12), that would normally be treated as un-coded, at positions where at least one pre-calculated metric (e.g., coding complexity measure) differs significantly (e.g., fulfilling the predetermined criterion) for the said pictures, e.g., from an average metric calculated over a representative number of pictures (e.g., reference set of frames) of the current GOP and/or previous GOPs (e.g., sequence 54 of immediately consecutive frames 10). Without imposing restrictions, metrics (e.g., coding complexity measure) can be the visual activity, mean value, gradient and/or histogram data of one or more color planes; sample-wise differences between consecutive original pictures or consecutive motion compensated pictures.

It is noted that the coding complexity measure described above may be applicable to any disclosure herein related to coding complexity measure (e.g., with reference to spatial sub-sampling).

According to an embodiment, the encoder 14 may be configured so that the proper subset of the frames 10 of the sequence 54 of immediately consecutive frames 10 which belong to the respective temporal layer 62 exclusively, or at least, comprises the earliest frame 10 (e.g., in display order and/or coding order) among the frames 10 of the sequence 54 of immediately consecutive frames 10 which belong to the respective temporal layer 62. Alternatively, the encoder 14 may be configured so that the proper subset of the frames of the sequence 54 of immediately consecutive frames 10 which belong to the respective temporal layer 62 exclusively, or at least, comprises the earliest frame and the latest frame (e.g., in display order and/or coding order) among the frames 10 of the sequence 54 of immediately consecutive frames which belong to the respective temporal layer 62.

For example, in FIG. 4, temporal layer 3 (with reference sign 62d) of the first sequence 54a of immediately consecutive frames 10 (or GOP #1) comprises four frames 10, wherein an earliest frame 10 at display order position 1 (or coding order position 4) is selected to be in the set 52 of frames. Since the other three frames in temporal layer 3 are not part of the set 52 of frames, the proper subset of the frames 10 of the sequence 54 of immediately consecutive frames 10 which belong to the respective temporal layer 3 exclusively comprise the earliest frame 10 (e.g., at not the remaining three frames of the temporal layer 3) among the frames 10 of the sequence 54 of immediately consecutive frames 10 which belong to the respective temporal layer 3. Alternatively, the proper subset of the frames 10 of the sequence 54 of immediately consecutive frames 10 which belong to the respective temporal layer 3 may at least comprise (i.e. not exclusively comprise) the earliest frame 10 at display order position 1 and comprise further frames 10, e.g., frame 10 at display order position 3 (or coding order position 5).

In the example shown in FIG. 5, in which a scene change 64 is detected, temporal layers 3 and 4 (with reference signs 62d, e) each have a proper subset of the frames 10 that exclusively comprise an earliest frame 10 (e.g., at display order positions 1 and 2) and a latest frame 10 (e.g., at display order positions 14 and 15) among the frames 10 of the sequence 54 of immediately consecutive frames 10. However, the temporal layers 3 and/or 4 may comprise further frames in the respective layers 3 and/or 4 (e.g., one or more of frames 10 at display order positions 3, 5, 6, 7, 9, 10, 11, and 13).

Including exclusively an earliest frame 10 in the set 52 of frames 10, reduces the amount of frames of the temporal layer to a single frame (e.g., or two frames if the latest frame is included), which can reduce coding complexity. Including the latest frame 10 in the set 52 of frames 10 can include a frame 10 with content that may differ the most from the earliest frame 10 and therefore may increase the probability that the first-pass bitrate is more representative of the sequences 54 of immediately consecutive frames 10. Including more frames than the earliest and/or last frame may improve accuracy and/or allow including frames relevant to a scene change or frames with an unusual coding complexity measure as described above.

According to an embodiment, the encoder 14 may be configured to perform scene detection to detect scene changes 64, and select the set 52 of frames out of the sequence 54 of immediately consecutive frames 10 depending on whether any of the scene changes 64 falls into the sequence 54 of immediately consecutive frames 10 so that the set 52 of frames represents the sequentially sub-sampled subset of the sequence 54 of immediately consecutive frames of the media signal 11 in case of none of the scene changes 64 falling into the sequence 54 of immediately consecutive frames 10, and so that the set 52 of frames comprises all frames 10 of the sequence 54 of immediately consecutive frames 10 in case of any of the scene changes 64 falling into the sequence 54 of immediately consecutive frames 10.

Therefore, the first-pass coding 50 may be performed with the entire sequence 54 of immediately consecutive frames 10, in case of any of the scene changes 64 falling to the sequence 54 of immediately consecutive frames 10.

According to an embodiment, the encoder 14 may be configured to perform scene detection to detect scene changes 64, and select the set 52 of frames 10 out of the sequence 54 of immediately consecutive frames 10 depending on which frame 10 within the sequence 54 of immediately consecutive frames 10 any of the scene changes 64 coincides with (e.g., frames 10 that are part of a scene transition, e.g., a fade out or a fading between two scenes) so that the set 52 of frames comprises, for each of a set of different frame types (e.g., temporal layer ID, e.g., wherein one type of frames references another type of frames, e.g., a temporal layer referencing one or more lower temporal layers), at least one frame 10 of the respective frame type, and the set 52 of frames represents a sequentially sub-sampled subset of a sequence 54 of immediately consecutive frames 10 of the media signal 11.

In the example shown in FIG. 4, the sequence 54 of immediately consecutive frames 10 of the media signal 11 comprises four sets of different frame types in form of four temporal layers 0 to 3. The set 52 of frames may comprise, for each of a set of different frame types (e.g., the different temporal layers 0 to 3) at least one frame 10 of the respective frame type, e.g., frames with the coding order position 1 (for the temporal layer 0), 2 (for the temporal layer 1), 3 (for the temporal layer 2), and 4 (for the temporal layer 3). However, as can be seen in FIG. 4, the set 52 of frames may comprise additional frames (e.g., the frame 10 with the coding order position 6).

The set 52 of frames may comprise, for each frame type (e.g., temporal layer) of which at least one frame 10 exists in the sequence 54 of immediately consecutive frames 10, which temporally precedes the frame 10 of the scene change 64 (e.g., for frames 10 with a display order position smaller than the scene change 64), and at least one frame 10 exists in sequence 54 of immediately consecutive frames 10, which temporally follows, or coincides with, the frame of the scene change 64 (e.g., for frames 10 with a display order position equal to or greater than the scene change 64), a subset of one or more frames 10 of the at least one frame in the sequence of immediately consecutive frames, which temporally precedes the frame 10 of the scene change 64, and a subset of one or more frames 10 of the at least one frame 10 in the sequence 54 of immediately consecutive frames, which temporally follows, or coincides with, the frame of the scene change 64.

For example, FIG. 5 shows a scene change 64 between display order positions 9 and 10. The frame 10 at the display order position 10 may be defined as a frame of the scene change 64, as said frame is the first frame of a new scene. As a result, frames on display order positions 1 to 9 temporally precede the frame 10 of the scene change 64 and frames on display order positions 10 to 16 temporally follows, or coincides with, the frame 10 of the scene change 64.

In FIG. 5, temporal layers 0 and 1 respectively only have one frame 10 and therefore do not comprise a frame that is both, preceding and following the scene change 64. Consequently, temporal layers 0 and 1 do not form a frame type of which at least one frame exists in sequence 54 of immediately consecutive frames, which temporally precedes the frame of the scene change 64, and at least one frame exists in sequence 54 of immediately consecutive frames, which temporally follows, or coincides with, the frame of the scene change 64.

However, temporal layers 2 to 4 shown in FIG. 5 comprise at least one frame exists in sequence 54 of immediately consecutive frames, which temporally precedes the frame of the scene change 64 (e.g., the frame 10 at display order position 4 for temporal layer 2), and at least one frame exists in sequence 54 of immediately consecutive frames, which temporally follows, or coincides with, the frame of the scene change 64 (e.g., the frame 10 at display order position 12 for temporal layer 2).

The set 52b in FIG. 5 comprises for each frame type formed by temporal layers 2 to 4, a subset (e.g., frames 10 at display order positions 4, 2, and 1 for temporal layers 2 to 4) of one or more frames 10 of the at least one frame in the sequence of immediately consecutive frames, which temporally precedes the frame 10 of the scene change 64, and a subset (e.g., frames 10 at display order positions 12, 14, and 15 for temporal layers 2 to 4) of one or more frames 10 of the at least one frame 10 in the sequence 54 of immediately consecutive frames, which temporally follows, or coincides with, the frame of the scene change 64. In other words, for every temporal layer 62 that has at least one frame 10 in the first scene 66a and at least one frame 10 in the second scene 66b, the set 52 of frames 10 may comprise at least one frame 10 from each scene 66a, b in said temporal layer 62.

According to an embodiment, the encoder 14 may be configured to perform scene detection to detect scene changes 64 (e.g., including a scene transition), and select the set 52 of frames 10 out of the sequence 54 of immediately consecutive frames 10 depending on which frame 10 within the sequence 54 of immediately consecutive frames 10 any of the scene changes 64 coincides with so that the set 52 of frames 10 comprises all of one or more frames 10 affected by the scene change 64 and all frames 10 referenced, by way of inter-frame prediction, by the one or more frames 10 affected by the scene change 64.

Such a set 52 (or 52c) of frames 10 is exemplarily shown in FIG. 6, which comprises all frames 10 (e.g., frames at display order positions 7 to 11) affected by a scene change 64 (having a scene transition). The set 52 of frames 10 also comprises frames 10 outside the scene change that are referenced by the frames 10 within the scene change 64 (e.g., frames 10 at display order positions 6 and 12 in FIG. 6).

According to an embodiment, the encoder 14 may be configured to determine one or more coding complexity measures for each of the frames 10 of the sequence 54 of immediately consecutive frames 10. The encoder 14 may further be configured to determine the probe QP 56 for each of the set 52 of frames 10 based on the one or more coding complexity measures determined for the respective frame 10.

The encoder 14 may be configured to perform scene detection to detect scene changes 64, and select the set 52 of frames 10 out of the sequence 54 of immediately consecutive frames 10 depending on which frame 10 within the sequence 54 of immediately consecutive frames 10 (e.g., GOP) any of the scene changes 64 coincides with so that the set 52 of frames 10 comprises all of one or more frames 10 whose one or more coding complexity measures fulfill a predetermined criterion (e.g. differs by more than a predetermined threshold from an average of) with respect to the one or more coding complexity measures of a reference set of frames 10 including one or more of, all of, or all of remaining frames 10 of the sequence 54 of immediately consecutive frames 10, or one or more, or all of frames 10 of one or more preceding sequences 54 of immediately consecutive frames 10.

The encoder 14 may be configured to determine coding complexity measure upon determining that the scene change 64 falls within the sequence 54 of immediately consecutive frames 10 (e.g., GOP). The scene change 64 may therefore serve as an indication that coding complexity measure are to be investigated.

The encoder 14 may be configured to determine the coding complexity measure only for the frames 10 that coincide with the scene change 64. Scene changes 64 may be a particular source of increased coding complexity measure, allowing investigation of coding complexity measure to be limited to particularly important frames 10.

According to an embodiment, the media signal 11 is (or comprises) a video.

The general idea with temporal sub-sampling according to at least one of the three aspects above is that instead of full input encoding of the first pass in a constrained configuration, it is possible to skip one or multiple frames. In one example of this invention, the complete encoding of at least one frame is allowed for each Temporal Layer (TL) in each group of pictures (GOP) (with higher TLs usually containing more frames). Remaining frames (e.g., frames of the GOP that are not encoded and/or analyzed in the first pass) can be skipped and missing statistical information (e.g., a first-pass bitrate) of these (remaining) frames which may be needed for the second pass can be reused (e.g., the same information or a modified version thereof) from the already analyzed frames (e.g., encoded in the first pass) of the same TL (e.g., and/or other TL). In another example, potentially unnecessary pre-filter stages in the encoder, such as motion compensated temporal filtering (MCTF) for the unused frames (e.g., frames not encoded and/or analyzed in the first pass), can also be skipped, e.g., in case of two-pass encoding (e.g., in look-ahead based RC encoding the frames skipped in the first pass may be processed further in the second pass and thus may or may not require the pre-filtering).

Advantages of temporal sub-sampling may include:
1. The number of encoded frames may be reduced. For example, for a GOP length of 32 the number of encoded frames may be reduced from 32 to 6, and for a GOP length of 16, the number of encoded frames may be reduced from 16 to 5 (e.g., from the number of pictures or frames in a GOP to the number of temporal layers in a GOP).
2. Easy implementation without changing the encoder architecture. The encoding method disclosed herein may be compatible with commonly used sequences 54 of immediately consecutive frames (or GOP).
3. Statistics from the first pass for non-encoded frames may be inferred from already encoded frames, e.g., by copying a value (e.g., of the first-pass bitrate) of an encoded picture or frame in the same temporal layer as the non-encoded frame. This method usually provides a good-enough approximation for the non-encoded frames for the RC to operate efficiently.

Temporal sub-sampling is described herein may comprise further enhancements. As described above, if a scene-change occurs within a GOP, such an extrapolation might cause a large drift adversely affecting the RC results. According to an embodiment, to resolve such an issue, for GOPs in which a scene change is detected, the temporal subsampling may be deactivated, providing exact per-frame measurements, for example, of fixed-QP first pass encoding.

A second variant or example to process a picture (or frame) 10 of a sequence 54 of immediately consecutive frames (e.g., GOP) that is affected by a scene change 64 in the first pass may comprise one or more of the following embodiments or features:

In the case the detected scene change 64 is a single hard scene-cut (e.g., wherein a last frame 10 of a previous scene is directly followed by an earliest frame 10 of a subsequent scene, e.g., without a transition) within the GOP, a reduced number of pictures or frames 10 may be encoded in the first pass incorporating for each temporal layer (TL) at least one picture of each of the two scenes, if available (e.g., for every temporal layer, which comprises at least one frame 10 temporally before the scene change 64 and at least one frame 10 temporally after the scene change 64, e.g., for every temporal layer, which comprises at least one frame 10 in a first scene 66a and at least one frame 10 in a second scene 66b, separated from the first scene 66a by the scene change 64), as illustrated exemplarily in FIG. 5. Depending on the position (e.g., position in a display order) of the scene cut (e.g., scene change 64) within the GOP, the number (or amount) of coded pictures or frames 10 (e.g., in the first-pass encoding) may adapt (e.g. for a GOP having 16 frames (e.g., GOP16) it may range from 5 to 8 pictures and for GOP having 32 frames (e.g., GOP32) from 6 to 10 pictures).

In a variant or example, a fixed number of pictures or frames 10 may be coded in the first pass (e.g., the set 52 of frames 10 may comprise frames 10 depending on their display order position in its respective temporal layer 62), regardless of the scene-cut position in the GOP (e.g., independent of whether a scene change 64 is detected (or occurs) and/or independent of a temporal position of a scene change 64), that comprise, for example the first picture (e.g., one or more earliest frames 10 in display order) and the last pictures (e.g., one or more latest frames 10 in display order) of each TL (e.g., wherein, in this context, in a TL with only one frame, the one frame may be considered both, a first and last frame 10 of the TL) in the GOP.

In either case, for all non-coded pictures (e.g., all frames 10 of the GOP that are not encoded in the first pass, e.g., that are not part of the set 52 of frames 10), the captured statistical information may be inherited from the coded pictures (e.g., frames 10 of the GOP that have been encoded in the first pass) of a particular TL to not coded pictures of the same TL, e.g., if they belong to the same scene, providing the second pass with statistical information for all pictures in the GOP.

Statistical information may comprise at least one of a first-pass bitrate, data for determining the first-pass bitrate, and data derivable from the first-pass bitrate (e.g., a start QP 58).

Determining, based on the first-pass bitrate for each of the set of frames 10, a start QP 58 for each of the sequence 54 of immediately consecutive frames 10, may comprise determining for a respective frame 10, which has not been encoded in the first pass (e.g., of remaining frames of the sequence 54 of immediately consecutive frames 10), a start QP 58 based on a start QP 58 and/or a first-pass bitrate of one or more different frames 10 of the same temporal layer as the respective frame 10 (e.g., of a same scene if a scene change 64 occurs), wherein the one or more different frames 10 has been encoded in the first pass.

The start QP 58 of the respective frame 10 may be identical to (e.g., copied from) the different frame 10 of the same temporal layer. The start QP 58 of the respective frame 10 may be an average (e.g., arithmetic of geometric) or median of more than one different frames 10 of the same temporal layer. The start QP 58 of the respective frame 10 may be a modified version of the start QP 58 of the different frame 10 (or the average start QP) of the same temporal layer. For example, the start QP 58 of the respective frame 10 may be scaled down or scaled up by a fixed amount or factor (e.g., in order to ensure a certain bitrate or image quality). In a different example, the start QP 58 of the respective frame 10 may be scaled down or scaled up by depending on further information inferable from the respective frame 10 (e.g., depending on a coding complexity measure determined for the respective frame 10).

Deriving statistical information may comprise determining a start QP 58 of a remaining frame 10 (e.g. a frame 10 of the sequence 54 of immediately consecutive frames 10 that has not been encoded in the first pass) based on a start QP 58 and/or a first-pass bitrate of one or more different frames 10 of the same temporal layer as the respective frame 10 as described above.

For example, FIG. 5 shows a GOP, in which proper subsets of frames 10 have been selected for temporal layers 3 and 4. As a result, frames 10 at display order positions 1, 2, 14, and 15 have been first-pass encoded, but frames 10 at display order positions 3, 5, 6, 7, 9, 10, 11, and 12 have not been first-pass encoded. As indicated in FIG. 5 with dashed arrows, for the frames 10 that have not been first-pass encoded, statistical information may be derived from the frames 10 of the respective temporal layer that have been first-pass encoded. For example, In layer 4, for frames 10 at display order positions 3, 5, 7, and 9 (e.g., frames of the first scene 66a) the start QP 58 may be determined to be identical as the start QP 58 determined for the frame 10 at display order position 1. Similarly, in layer 4, for frames 10 at display order positions 11 and 13 (e.g., frames of the second scene 66b) the start QP 58 may be determined to be identical as the start QP 58 determined for the frame 10 at display order position 15. However, the start QP 58 for the frames 10 not encoded in the first pass may be determined in any other way as described herein.

Determining, based on the first-pass bitrate for each of the set of frames, a start QP 58 for each of the sequence of immediately consecutive frames may comprise prioritizing one or more frames 10 of a plurality of first-pass encoded frames 10 of the same temporal layer. The one or more frames 10 may be prioritized according to a coding complexity measure (e.g., any coding complexity measure disclosed herein, e.g., visual activity). Prioritizing one or more frames 10 of the plurality of first-pass encoded frames 10 of the same temporal layer may comprise at least one of omitting one or more frames 10 with a highest coding complexity measure (e.g., or exceeding a threshold for the coding complexity measure), weighting the plurality of first-pass encoded frames 10 (e.g., forming a weighted average for a start QP 58), omitting one or more frames 10, which have been first-pass encoded due to their coding complexity measure, and omitting one or more frames 10, which have been first-pass encoded due to said frames 10 coinciding with a scene change 64.

For example, FIG. 6 shows a GOP, in which proper subsets of frames 10 have been selected for temporal layer 4. Furthermore, the GOP comprises a scene change 64 with a transition, wherein frames 10 of the transition have been included in the set 52 of frames 10. The frames 10 of the transition may differ significantly from frames 10 of the first and second scene 66a, 66b. For example, the scene change 64 may comprise frames 10 that form a blending between the first and second scenes 66a, 66b. Therefore, the frames 10 of the scene change 64 may require a different QP start 58 compared to the frames 10 of the first and second scene 66a, 66b. Therefore, the frames 10 of the scene change 64 may be omitted (or weighted lower) when determining the start QP 58 for the frames 10 of the first and second scenes 66a, 66b that have not been first-pass encoded. For example, in FIG. 6, the start QP 58 of the frames 10 at display order positions 3 and 5 may be set identical to the start QP 58 of the frame 10 at the display order position 1 (e.g., regardless of the start QP 58 determined for the frames 10 of the scene change 64). Similarly, the start QP 58 of the frames 10 at display order position 13 may be set identical to the start QP 58 of the frame 10 at the display order position 15. However, the start QP 58 for the frames 10 not encoded in the first pass may be determined in any other way as described herein. Such inheritance of statistical information is exemplarily indicated in FIG. 6 with a dashed arrow.

FIG. 7 shows a GOP, in which proper subsets of frames 10 have been selected for temporal layers 3 and 4. Furthermore, the set 52 of frames 10 comprises all of one or more frames 10 whose one or more coding complexity measures fulfill a predetermined criterion. In other words, for the frames 10 at display order positions 9 and 10 of FIG. 7, a coding complexity measures may have been determined that exceeds a threshold, resulting in said frames 10 to be first-pass encoded. However, due the unusual coding complexity measures of said frames, their start QP 58 may differ significantly for start QPs 58 that would be adequate for the other frames 10 of the respective temporal layers 3 and 4. Therefore, the frames 10 whose one or more coding complexity measures fulfill a predetermined criterion may be omitted (or weighted lower) when determining the start QP 58 for the frames 10 of the same temporal layers 3 and 4 that have not been first-pass encoded. For example, the start QP 58 of the frames 10 at display order positions 3, 5, 7, 11, 13, and 15 may be set identical to the start QP 58 of the frame 10 at the display order position 1 (e.g., regardless of the start QP 58 determined for the frames 10 at the display order position 9). Similarly, the start QP 58 of the frames 10 at display order positions 6 and 14 may be set identical to the start QP 58 of the frame 10 at the display order position 2 (e.g., regardless of the start QP 58 determined for the frames 10 at the display order position 10). However, the start QP 58 for the frames 10 not encoded in the first pass may be determined in any other way as described herein. Such inheritance of statistical information is exemplarily indicated in FIG. 7 with a dashed arrow.

In the case that the detected scene change 64 is not a hard cut but comprises a transition as exemplarily illustrated in FIG. 6, i.e. for scene changes 64 where pictures or frames 10 of the two scenes (e.g., first and second scenes 66a, b) are affected by editing effects like dissolves, wipes and others, the above described enhancement may be applied and furthermore the pictures or frames 10 affected by editing effects, as well as their un-coded (e.g., frames 10 not encoded or would not have been encoded in the first pass) references pictures (e.g., frames 10 of the sequence 54 of immediately consecutive frames 10 that are not part of the scene change 64 but are referenced by frames 10 of the scene change 10, e.g., frames 10 at display order positions 6 and 12 in FIG. 6), may also be coded in the first pass. As mentioned before, the statistical information (e.g., a first pass bitrate and/or a start QP 58 or information derivable or derived therefrom) for all un-coded pictures or frames 10 (e.g., frames 10 not encoded in the first pass, e.g., frames 10 not included in the set 52 of frames 10) may be derived from coded pictures (e.g., frames 10 encoded in the first pass) not affected (e.g., not falling into the scene change 64, e.g., falling into the first or second scene 66a, b) by editing effects of the same TL, if the un-coded pictures belong to (e.g., fall into) the same scene (e.g., first or second scene 66a, b).

Additionally or alternatively, (e.g., independent from the scene-change use case), e.g., to capture temporarily effects within one scene (e.g. flash lights, see exemplarily frames 10 at display order positions 9 and 10), it is proposed for a temporal down-sampled first pass (e.g., for a restricted first-pass encoding as described herein), for example as described above with reference to deactivating temporal subsampling, to inject coded pictures (e.g., selecting the set 52 so as to include frames 10), as well as their un-coded references pictures (e.g., one or more frames 10 that do not contain the temporary effects but are referenced by one or more frames 10 that include the temporary effects), that would normally be treated as un-coded (e.g., that normally would not have been selected for the set 52 for the first-pass encoding), at positions (e.g., display order or coding order positions) where at least one pre-calculated metric (e.g., one or more coding complexity measures) differs significantly (e.g., fulfill a predetermined criterion) for the said pictures from an average metric calculated over a representative number of pictures of the current GOP and/or previous GOPs (e.g., with respect to the one or more coding complexity measures of a reference set of frames 10 including one or more of, all of, or all of remaining frames 10 of the sequence 54 of immediately consecutive frames 10, or one or more, or all of frames 10 of one or more preceding sequences 54 of immediately consecutive frames 10). Without imposing restrictions, metrics can be the visual activity, mean value, gradient and/or histogram data of one or more color planes; sample-wise differences between consecutive original pictures or consecutive motion compensated pictures.

As noted, the above proposal (e.g., restricting the first-pass encoding onto a set 52 of frames 10 out of a sequence 54 of immediately consecutive frames 10) reduces the number of frames 10 which need to be encoded in the first RC pass, e.g., from GOP size to some value between the GOP size and 1+log 2(GOP size), inclusive. For example, the GOP #1 54a shown in FIG. 4 has a total of eight frames 10. If only one frame 10 of each temporal layer is selected for the set 52, four frames 10 would be selected (disregarding frame 10 at display order position 6 for the present example), which corresponds to an amount of frames of 1+log 2(8)=1+3=4. In the example shown in FIG. 5, the GOP 54 has a total of 16 frames 10. If only one frame 10 of each temporal layer is selected for the set 52, five frames 10 would be selected (disregarding the case of a scene change 64 for the present example), which corresponds to an amount of frames of 1+log 2(16)=1+4=5. However, it is noted that the sequence 54 of immediately consecutive frames 10 (e.g., GOP) does not necessarily require a temporal structure, in which an amount of frames 10 in a temporal layer doubles compared to the temporal lower directly below.

According to a further embodiment, a generalization, allowing for intermediate solutions may be devised by activating the inventive skipping of first-pass frame encoding, for example, only at or above a certain predefined temporal layer threshTL (e.g., k). In other words, during the first encoding pass, prior to starting the encoding (e.g., first-pass encoding) of each frame in each GOP, a comparison is made between that frame's TL value and the threshTL value, and, for example, only when said TL value is equal to or greater than threshTL, said remaining frames in said TL (e.g., the same-TL frames after the first one in said GOP) may be skipped. For example, for a GOPsize of 32 (e.g., sequence 54 of immediately consecutive frames 10 having a total of 32 frames 10), a good value for threshTL might be 3, resulting, for example, in 7 frames being encoded (first pass encoded) in each GOP in the first RC pass. The reason for this being that, in such an example, the other frame (e.g., frame 10 at display order position 12 in FIG. 5) in TL2 may also be encoded, TLO and 1 both only contain a single frame (note, however, that there are many other GOP types possible and the present invention is not restricted to any kind of GOP structure; in particular, the encoding may take place using a dynamic GOP structure). In this manner, a finer tradeoff between encoding speed and coding efficiency (i.e., compression performance) may be achieved, thereby allowing the invention to be used, for example, in combination with relatively slow second-pass encoding configurations as well, where the relative runtime overhead of the first pass encoding is lower.

### Spatial Sub-Sampling

In the following, the second main aspect related to spatial sub-sampling will be described. As already discussed above, the disclosure of temporal sub-sampling and spatial-sampling herein is not exclusive to each other and can be combined in their respective entirety or only aspects or features of one sub-sampling type can be combined with aspects and features of the other sub-sampling type. An encoder 14 is provided for encoding a media signal using a spatially sub-sampled version of the media signal. The encoder 14 may have any feature in isolation or in any combination with any other feature disclosed above, e.g., any feature of a general encoder with reference to FIGS. 1 and 2, as well as any features of the encoder 14 configured to perform temporal sub-sampling (e.g., with reference to FIG. 4 to 7).

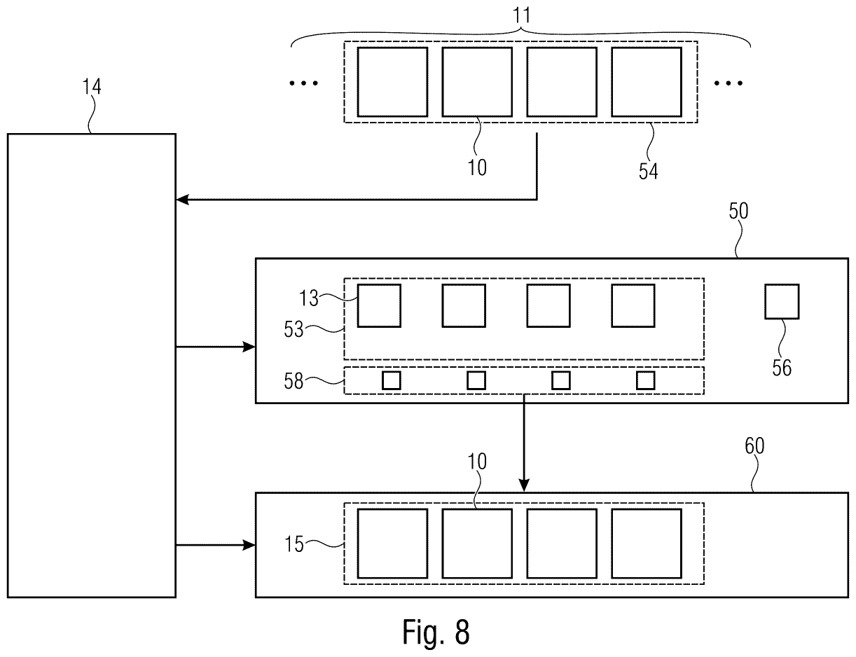

FIG. 8 shows a schematic example of an encoder 14 for encoding a media signal 11. The encoder 14 is configured to perform a first-pass encoding 50 of a spatially sub-sampled version 53 of the media signal 11 (e.g., including sub-sampled versions 13 of the frames 10) using a probe QP 56 so as to obtain first-pass bitrates 58 for frames 10 of the media signal 11, determine, based on the first-pass bitrates, start QPs 58 for the frames 10 of the media signal 11; and perform a second-pass encoding 60 of a not spatially sub-sampled version 15 of the media signal 11 with using the start QPs 58.

Spatial sub-sampling the media signal 11 may comprise generating a modified version of at least one frame 10 of the media signal 11, from which spatial information of one or more sample values (e.g., pixel values, luma values, chroma values) are omitted (or skipped or removed) and/or spatial information of multiple sample values is combined (or condensed or summarized, e.g., by forming a mean median value) to a smaller subset of sample values. For example, spatial sub-sampling may remove every other row and/or column of pixels, effectively halving a height and/or width of a frame 10. Alternatively or additionally, sample values of sample arrays of 2×2 pixels may be combined (e.g., averaged) to a single sample value. In these two examples, the sub-sampled version of the media signal 11 may result in frames 11 with one fourth (¼) of the amount of samples (e.g., pixels) than without sub-sampling. However, any other factor for sub-sampling may be used. Furthermore, any other method or combination of methods for sub-sampling may be used.

Another opportunity of first pass sub-sampling is to operate in the spatial domain. For example, an original resolution of the input (e.g., a resolution of frames 10 of the media signal 11 before spatial sub-sampling) can be sub-sampled, for example, with step S, for example with a factor that depends on step S (e.g., reducing a width and height of the full-resolution picture by 2^{S}, or a^{S} with a∈N or [symbol] ) and the first pass can operate on the lower resolution (e.g., a quarter of the resolution for S=1 or an eights of the resolution for S=2 in case the factor is determined as 2^{S}). It is noted that the sub-sampling leads to a sub-sampled version of the video which does not necessarily form any spatial layer or the like of the resulting data stream, i.e. the one resulting from the second-pass encoding, i.e. is not necessarily a reconstructible version of the data stream. Instead, the spatially sub-sampled version may be used for the purpose of performing the first-pass encoding. However, the spatially sub-sampled may be used for other encoding procedures (e.g., for obtaining statistical information or encoding differently sized versions of the media signal). The encoder 14 may be configured (e.g., similar to the VVenC's RC method) to determine the overall QP (e.g., a probe QP 56) for the first pass, for example, using video dimensions (width and height) and a target bitrate. With changing the resolution of the input (e.g., of the media signal 11), a recalculation of the target rate for the first pass may be needed. The overall QP (e.g., the probe QP 56) for the modified first pass (e.g., using the spatially sub-sampled version 13 of the media signal 11) can be also modified (e.g. −1 or −2, e.g., reducing the probe QP 56 by any integer number such as one, two, three, four, or more), to refine the first pass and increase the approximation accuracy of the full-size bitrate (e.g., start QP 58) from the sub-sampled bitrate.

If the frames 10 are (e.g., spatially) sub-sampled for the encoding in the first pass, the statistical information (e.g., at least one of a first-pass bitrate and a probe QP 56) may not be directly applicable to the second pass, which can perform the encoding at the original resolution (e.g., a resolution of the media signal 11 without being spatially sub-sampled). The information (e.g., at least one of the first-pass bitrate and the probe QP 56) on the first pass per-frame rate (numBitsᵢ) may have to be adjusted. First, approximations of full-size required per-frame fixed QP (numBits_{i_2.pass}) (e.g., start QPs 58) bits may have to be extrapolated from the collected data (e.g., at least one of the first-pass bitrate and the probe QP 56), e.g. using the sub-sampling step S or the factor dependent on step S. Extrapolating the bits (e.g., the start QPs 58) using just multiplier S might not work well in the context of rich motion, multiple scene changes or noise.

According to an embodiment, the first-pass encoding 50 may involve an encoder-search space which is reduced compared to the second-pass encoding. The encoder-search space may be reduced as described above with reference to temporal sub-sampling. For example, an interval for block sizes may be restricted or reduced (e.g., to block sizes of 4×4, 8×8, and 16×16 pixels) in the first pass 50 compared to the second pass 60. Alternatively or additionally, the encoder-search space may be limited to a certain frames 10 (e.g., of only a preceding or lowest temporal layer). As a result, encoding complexity may be reduced.

According to an embodiment, the first-pass encoding 50 may operate using rate-distortion optimization at variable rate and the second-pass encoding 60 may operate using rate-distortion optimization in a rate-controlled manner. Therefore, the rate-distortion may be adjustable to the probe QP for the first-pass encoding 50 and adjustable to the start QP for the second-pass encoding 60.

According to an embodiment, the encoder 14 may be configured to perform the first-pass encoding 50 onto consecutive sequences (e.g., in coding order and/or display order) of immediately consecutive frames 10 (e.g., in coding order and/or display order) of the media signal 11 before performing the second-pass encoding 60 onto each of the consecutive sequences of immediately consecutive frames. The consecutive sequences may be group of pictures such a groups of pictures of 8, 16, 32, or 64 (or larger and/or not necessarily a power of two) frames 10. The consecutive sequences may be defined by duration (e.g., second or minutes) or amount of frames. The consecutive sequences may have identical duration and/or amount of frames or have different duration and/or amount of frames.

The one or more consecutive sequences of frames 10 may be realized according to any disclosure above related to temporal sub-sampling.

For example, the media signal 11 may be subdivided into the consecutives sequences before or during first encoding 50. Once the encoder 14 has finished the first-pass encoding 50 of all consecutive sequences, the encoder 14 may begin performing the second-pass encoding 60 onto each of the consecutive sequences of immediately consecutive frames (e.g., in the same or different order as the first-pass encoding 50).

Alternatively, the encoder 14 may be configured to perform the first-pass encoding 50 and the second-pass encoding 60 onto consecutive sequences of immediately consecutive frames of the media signal in an interleaved manner. The consecutive sequences may be defined in any way as described above. The encoder 14 may be configured to perform the first-pass encoding 50 and second-pass encoding 60 in series (e.g., only one type of first or second pass encoding at a time) or at least partially in parallel. For example, the encoder 14 may be configured to perform a first-pass encoding 50 of a first consecutive sequence of immediately consecutive frames 10 while also performing the second pass encoding 60 on a second consecutive sequence of immediately consecutive frames 10 that precedes (directly or indirectly) the first consecutive sequence of immediately consecutive frames 10.

According to an embodiment, the encoder 14 may be configured to determine, based on the first-pass bitrates, start QPs 58 for the frames 10 of the media signal 11, by determining estimated first-pass bitrates, estimated to be obtained as if the fist-pass encoding was performed on the not spatially sub-sampled version 15 of the media signal 11, and determining the start QPs 58 based on the estimated first-pass bitrates. For example, the medial signal 11 may be spatially sub-sampled to have frames 10 with a fourth of the original frame size (e.g., by halving both a width and height of each frame 10). The encoder 14 may subsequently perform the first-pass encoding 50 of the spatially sub-sampled frames 10 (e.g., independent from the fact that the frames 10 have a different size). Since the spatial sub-sampling commonly reduces information of the content, each frame requires a smaller amount of data to be encoded for the first-pass encoding 50. As a result, the estimated first-pass bitrates may be smaller compared to a first-pass encoding without spatial sub-sampling. The encoder 14 may therefore be configured to determine the start QPs 58 based on a modified version of the estimated first-pass bitrates and/or a modified version of estimated start QPs 58 that are determined based on the estimated first-pass bitrates. For example, the start QPs 58 may be determined based on a function that maps the estimated first-pass bitrates (or estimated QPs determined from the estimated first-pass bitrates) onto the start QPs 58.

According to an embodiment, the encoder 14 may be configured to determine, based on the spatially sub-sampled version 13 of the media signal 11, at least one predetermined coding complexity measure (e.g., visual activity, e.g., relative to an average visual activity for a portion or the entire media signal 11) for each of the frames 10, and determine, for each of the frames 10, the estimated first bitrate (e.g., a bitrate obtained by performing a first-pass encoding of the spatially sub-sampled version of the media signal 11 and determining a bit rate that would be used or would be applicable if a second-pass encoding would be performed using the sub-sampled version of the media signal 11) for the respective frame 10 based on the first bitrate obtained for the respective frame 10, and the at least one predetermined coding complexity measure for the respective frame 10, and determine, for each of the frames 10, the start QP 58 for respective frame 10 based on the estimated first bitrate determined for the respective frame 10 in a manner independent from the at least one predetermined coding complexity measure for the respective frame 10 (e.g., by taking the predetermined coding complexity measure already into account when determining the estimated first bitrate).

For example, the encoder 14 may be configured to perform the first-pass encoding 50 and to determine the visual activity based on the spatially sub-sampled version 13 of the media signal. The encoder 14 may then determine the estimated bitrate for each frame 10 based on the respective visual activity and first bitrate. For example, the estimated bitrate may be a larger version of the first bitrate if a larger predetermined coding complexity measure has been determined and vice versa. The encoder 14 may subsequently determine the start QP 58 based on the estimated bitrate. Since the predetermined coding complexity measure has already been considered for determining the estimated bitrate, the start QP 58 may be determined in a manner independent from the at least one predetermined coding complexity measure for the respective frame 10.

According to an embodiment, the media signal 11 may be or may comprise a video. The media signal 11 may be realized as described above with reference to temporal sub-sampling.

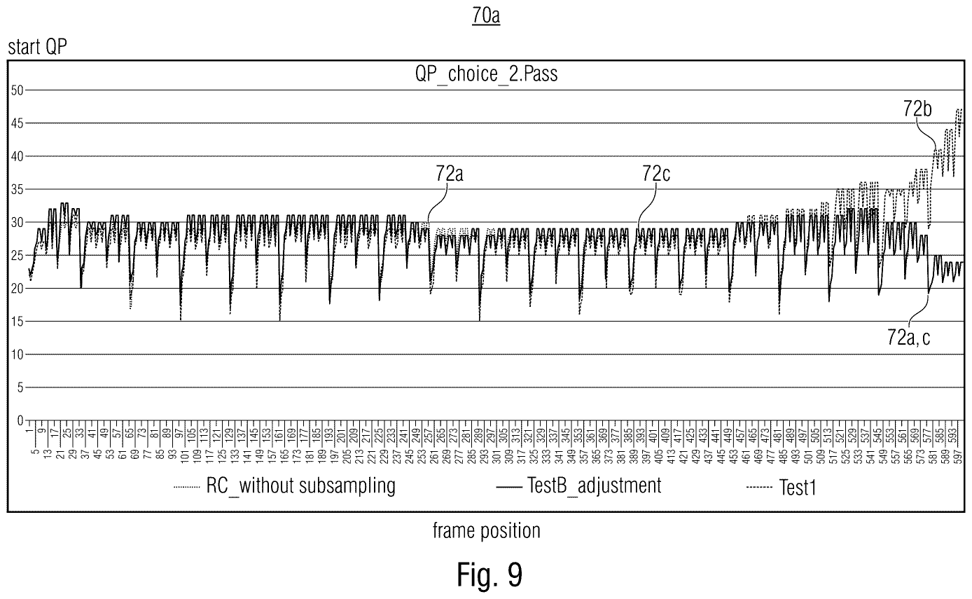

FIG. 9 shows an exemplary diagram 70a of start QPs 58 determined in three different approaches. The horizontal axis indicates a position or index of frames 10 encoded in subsequent order (e.g., frame 1 to frame 597). The vertical axis indicates a value for start QP 58 (e.g., from a QP of 0 to 50) determined for a frame number. A first line 72a shows start QPs 58 determined without spatial subsampling (e.g., RC without subsampling). A second line 72b (e.g., Test1) shows start QPs 58 determined using a first approach for spatial subsampling. A third line 72a (e.g., TestB-adjustment) shows QPs 58 determined using a second approach for spatial subsampling.

In other words, FIG. 9 shows QP choice in the second pass (e.g., start QPs 58 determined and used for a second-pass encoding 60). FIG. 9 shows used QP for each frame 10 in the final pass (e.g., second-pass encoding 10), after evaluation of the statistical information (e.g., first pass bitrate) from the first pass. The line 72a labelled RC_without_subsampling is indicative of an original two-pass RC algorithm (e.g., without spatial sub-sampling). The line 72b labelled Test1 is indicative of a two-pass RC with spatial subsampling with extrapolation of NumBits without signal adaptation. The line 72c labelled TestB_adjustment indicates a two-pass RC with spatial subsampling using a precalculated metric described further below (e.g., using value VisualActivity and Spatial VisualActivity).

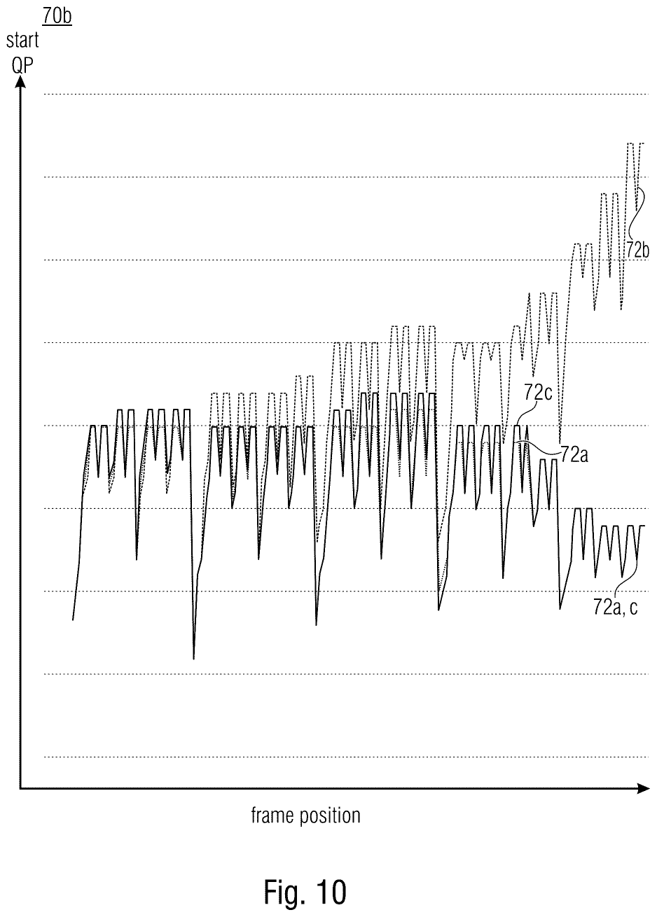

FIG. 10 shows a close up diagram 70b cutout of an end portion of a frame range of FIG. 9 (e.g., between frames 450 and 597).

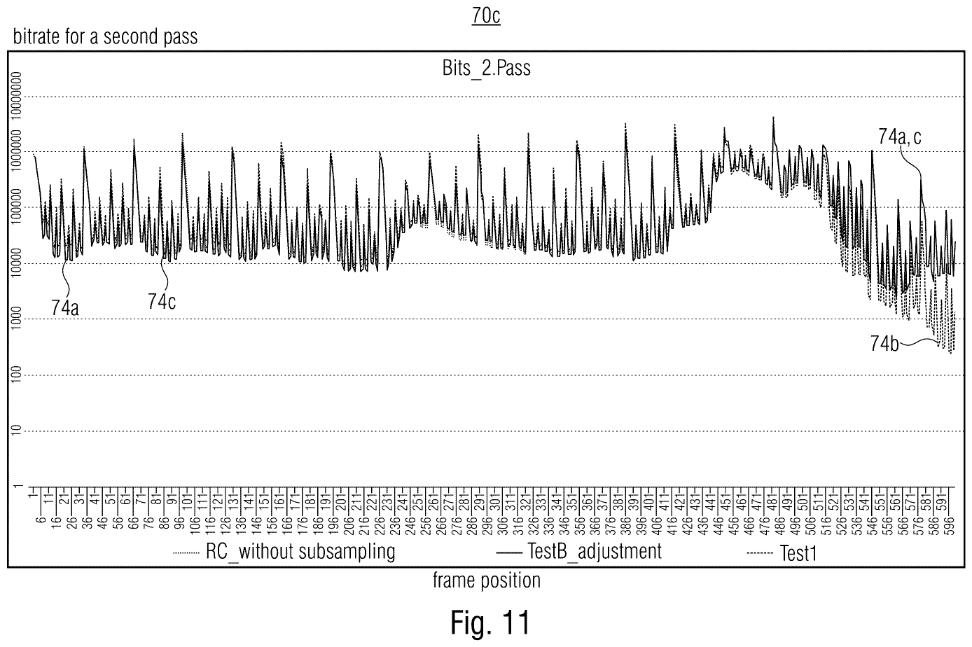

FIG. 11 shows an exemplary diagram 70c of bits used for each frame in three different approaches. The used bits shown in FIG. 11 may correspond to the start QPs 58 determined in FIG. 9. The horizontal axis indicates a position or index of frames 10 encoded in subsequent order (e.g., frame 1 to frame 597). The vertical axis indicates a value for start QP 58 (e.g., from a QP of 0 to 50) determined for a frame number.

In other words, FIG. 11 shows bits per frame in a second pass (e.g., an amount of bits used for each frame during a second-pass encoding 60). FIG. 11 shows used bits for each frame in the final pass (e.g., a second pass encoding 60), after evaluation of the statistical information from the first pass (e.g., after performing a second-pass encoding of a not spatially sub-sampled version 15 of the media signal 11 with using start QPs determined, based on the first-pass bitrates, start QPs for the frames of the media signal 11).

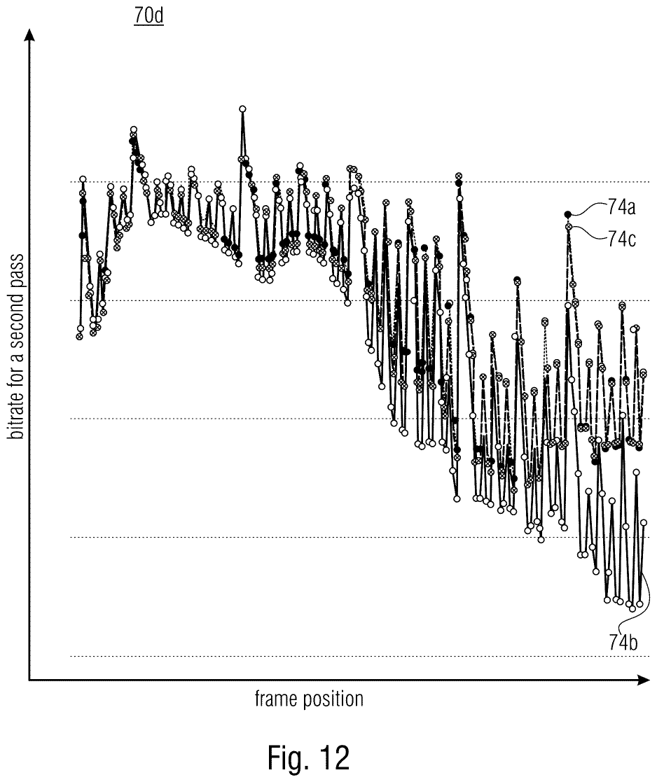

FIG. 12 shows a close up diagram 70b cutout of an end portion of a frame range of FIG. 11 (e.g., between frames 450 and 597).

FIG. 9 to 12 exemplarily show a deviation of the start QP (or bit number) for the second-pass encoding 60 that may occur when using spatial sub-sampling. Approximately at frame position 489 the two lines 72a and 72b (as well as lines 74a and b) start to diverge. Such a deviation may, for example, be caused by a significant change of visual activity in frames 10. Such a change may not sufficiently translate to the sub-sampled version of the media stream 11. Therefore, start QPs determined based on the first-pass with spatial sub-sampling may differ more strongly compared to start QPs determined without spatial sub-sampling.

In other words, FIG. 9 to 12 (e.g., wherein FIGS. 10 and 12 depict a zoom in on a critical area of FIGS. 9 and 11) show the differences in QP and bits per frame values (e.g., start QPs 58 and bits per frame) in the final pass (e.g., second-pass encoding 60) between RC without sub sampling (e.g., line 72a and 74a) and Test1 (e.g., 72b and 74b).

The higher the sub-sampling step (e.g., the larger a ratio between a non-sampled version and a spatially sub-sampled is, e.g., a factor of 2^{S}), the more challenging it may be to find an optimal unique factorization step for the entire content without big quality degradation.

In order to avoid or reduce the risk of spending a large part of the bit budget on irrelevant components and to meet the target rate by efficiently spending the bits, the following steps may optionally be used to adjust the statistical information for the second pass.

According to an embodiment, the encoder 14 may be configured to determine, based on the spatially sub-sampled version 13 of the media signal 11, one or more coding complexity measures for each of the frames 10, and determine the probe QP 56 for each of the frames 10 based on the one or more coding complexity measures determined for the respective frame 10. The one or more coding complexity measures may be defined and/or determined as already described therein. For example, the encoder 14 may be configured to determine a visual activity for one or more the spatially sub-sampled version 13 of the media signal 11 (e.g., each frame 10 may be scaled down to one fourth or any other portion of its original size, wherein the visual activity may be determined for each of the scaled down frames 10). The probe QP 56 may be determined based on a function that decreases with increasing visual activity (e.g., requiring finer quantization parameters in order to encode a higher visual activity).

In FIG. 9 to 12, the lines 72c and 74c correspond to start QPs 58 and bitrates determined based on the coding complexity measures of the respective frames. As can be seen, the lines 72c and 74c coincide much better with the lines 72a and 74a, which indicates a better representation of the start QPs 58 and bitrates when using spatial sub-sampling.

According to an embodiment, the encoder 14 may be configured to determine (e.g. based on the spatially sub-sampled 13 version of the media signal 11) at least one predetermined coding complexity measure for each of the frames 10, and determine, for each of the frames 10, the start QP 58 for respective frame 10 based on the first bit rate obtained for the respective frame 10, and the at least one predetermined coding complexity measure for the respective frame 10. The predetermined coding complexity measure of the respective frame may be determined based on a relationship of a coding complexity measure of the respective frame and value representative of a combination of coding complexity measures of a plurality of frames 10 (e.g., of an interval or window of frames 10 around or relative to the respective frame 10, e.g., of all frames of the media sample 11, e.g., of frames 10 of a portion of the media sample 11). For example, the at least one predetermined coding complexity measure of the respective frame may be determined based on (or as) a deviation (e.g., difference or absolute difference) of the coding complexity measure (e.g., visual activity) of the respective frame relative to an average (e.g., arithmetic or geometric) coding complexity measure of the plurality of frames 10.

The encoder 14 may be configured to determine a deviation in a precalculated metric (e.g., predetermined coding complexity measure) of one frame 10 or a group of frames (e.g., GOP, with an amount of 8, 16, 32, 64 of frames) from overall mean (e.g., a mean over all frames of the media sample 11) or the mean of a previous frame (e.g., an immediately or directly preceding frame in coding order) or previous group of frames (e.g., an immediately or directly preceding group of frames).

The predetermined coding complexity measure may be based on a visual activity and/or minimum motion estimation error (MMEE).

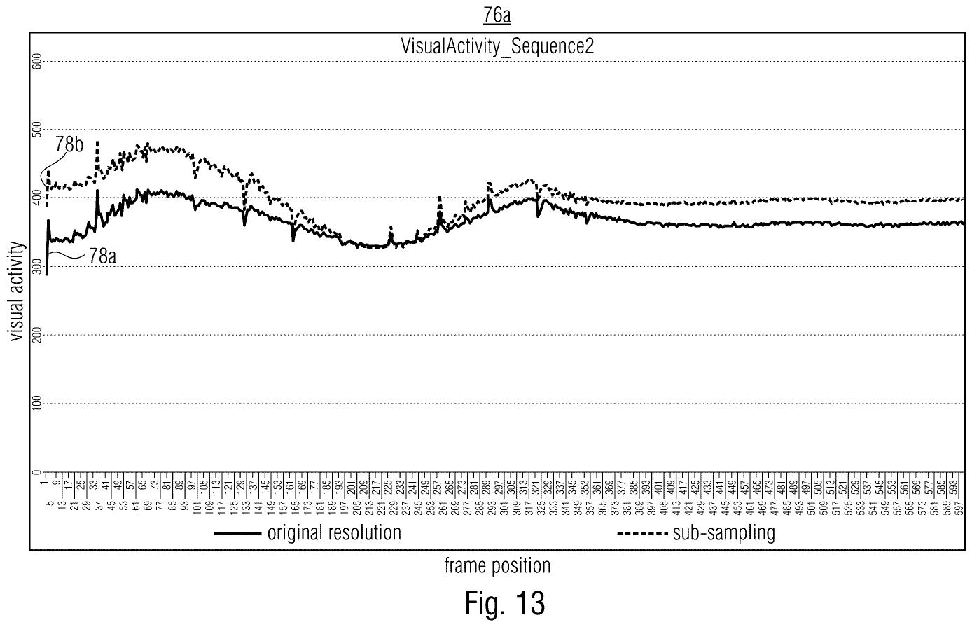

FIG. 13 shows an exemplary diagram 76a of visual activity determined for a media stream without and with spatial sub-sampling. The horizontal axis indicates a position or index of frames 10 encoded in subsequent order (e.g., frame 1 to frame 597). The vertical axis indicates a value for a visual activity (e.g., for values between 0 and 600) determined for a frame position. A first line 78a indicates a visual activity of a media sample 11 without spatial sub-sampling. A second line 78b indicates a visual activity of a media sample 11 after spatial sub-sampling. As can be seen in FIG. 13, the visual activity of both lines 78a, b can have a similar behavior (e.g., having local maxima at similar frame positions).

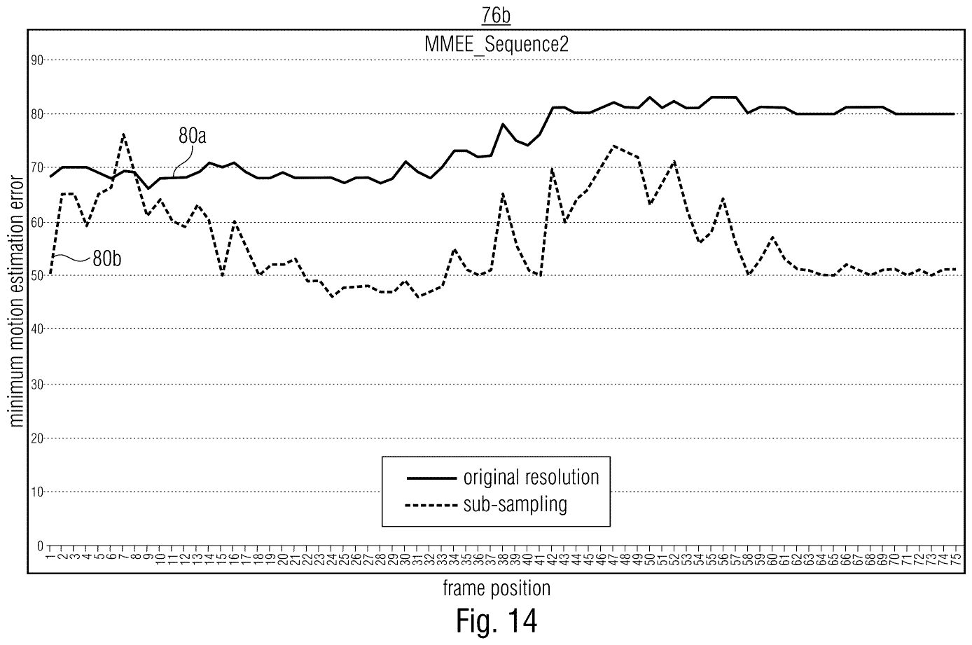

FIG. 14 shows exemplary diagram 76b of MMEE determined for a media stream without and with spatial sub-sampling. The horizontal axis indicates a position or index of frames 10 encoded in subsequent order (e.g., frame 1 to frame 597). The vertical axis indicates a value for an MMEE (e.g., for values between 0 and 90) determined for a frame position. A first line 80a indicates an MMEE of a media sample 11 without spatial sub-sampling. A second line 80b indicates an MMEE of a media sample 11 after spatial sub-sampling.

For example, this precalculated metric (e.g., a coding complexity measure) can be for example per fame SpatialActivity; (e.g. see FIG. 12) as, e.g., used in VVenC, but possibly also and/or the motion estimation error, e.g., of motion compensated temporal filtering MCTF (MMEEᵢ, see FIG. 14) [2][3], for example further generalized as Vᵢ. The arithmetic mean may be determined using the following equation:

$${V}_{mean} = \frac{{\sum }_{i} {V}_{i}}{N} \qquad equation ( 3 )$$

with a number N of frames (e.g., a total amount of frames of the media sample 11, all previous frames, or a group of frames, e.g., an amount of frames of a previous group of frames).

A mean value for Vₘₑₐₙ (e.g., a mean value of coding complexity measures) may be determined for all frames of the media sample 11 or for a portion thereof such as a group of pictures (e.g., comprising 8, 16, 32, or 64 frames). A mean value V_{meanGOP} of a GOP may, for example, be determined using the following equation:

$${V}_{meanGOP} = \frac{{\sum }_{{i}_{GOP}} {V}_{i}}{{N}_{GOP}} \qquad equation ( 4 )$$

with frame position or frame index of frames i_{GOP} from 1 to N_{GOP} frames. For example, a mean V_{meanGOP16} of a GOP with 16 frames may be determined using the following equation:

$${V}_{meanGOP 16} = \frac{{\sum }_{i = 1}^{16} {V}_{i}}{16} \qquad equation ( 5 )$$

with coding complexity measures Vᵢ of each frame of the group of pictures.

A standard deviation σ may be determined using the following formula:

$$σ = \sqrt{\frac{{\sum }_{i} {( \vert {V}_{i} - {V}_{mean} \vert )}^{2}}{N}} \qquad equation ( 6 )$$

wherein a frame index or frame position i may indicate frames within a group of frames (e.g., a current or previous group of friends), all previous frames, or of all frames of the media signal 11. The mean value Vₘₑₐₙ may define a mean value of coding complexity measures of a group of frames (e.g., a current or previous group of friends) or all frames of the media signal 11.

According to an embodiment, the encoder 14 may be configured to determine (e.g. based on the spatially sub-sampled version 13 of the media signal 11) at least one predetermined coding complexity measure (e.g., a visual activity and/or an MMEE of a frame) for each of the frames 10, and determine, for each of the frames, the start QP 58 for respective frame 10 based on the first bit rate obtained for the respective frame 10, and a measure of deviation (e.g. R1, R2 or R3 as will be described in more detail below) of the respective frame from a reference set of one or more frames (e.g., a previous frame or a previous group of frames or all previous frames, excluding or including the (current) frame, i.e. the group may merely cover a subset of previous frames or all previous frames) in terms of the at least one predetermined coding complexity measure for the respective frame.

For example, the measure of deviation may be representative of how much a visual activity (and/or any other coding complexity measure) deviates from the coding complexity measure of a previous frame (e.g., immediately previous frame) or deviates from a combined value (e.g., a mean and/or standard deviation) of a plurality of frames (e.g., a current group of frames, a previous groups of frames, all frames, or all previous frames).

For example, the deviation (e.g., measure of deviation) can be determined by means of:
a) The ratio between absolute deviation of VisualActivity of a frame and the standard deviation, e.g.:

$$R 1 = \frac{\vert {V}_{i} - σ \vert}{σ} \qquad equation ( 7 )$$

In a different embodiment, the ratio between absolute deviation of VisualActivity of a frame and the standard deviation, e.g.:

$$R 1 = \frac{\vert {V}_{i} - {V}_{mean} \vert}{σ} \qquad equation ( 8 )$$

According to an embodiment, the encoder 14 may be configured to determine (e.g. based on the spatially sub-sampled version 13 of the media signal 11) the at least one predetermined coding complexity measure (e.g. Vᵢ, e.g., R1) for each of the frames (e.g., with frame position or frame index i) by determining sample values (e.g., pixel values, e.g., chroma values and/or luma values, e.g., difference amongst neighboring pixel values) for the at least one predetermined coding complexity measure at each of different spatial frame portions (e.g., at pixels or coding blocks) within the respective frame (e.g., a visual activity of pixels of a frame, e.g., of a mean of visual activities determined for blocks of a frame 10) and averaging (e.g. arithmetic or geometric mean) over the sample values (e.g., based on or formed by luma and/or chroma values or differences thereof relative to neighboring samples or pixels) to obtain a current average (e.g., Vᵢ) of at least one predetermined coding complexity measure. Any disclosure of coding complexity measure herein (e.g., with reference to temporal sub-sampling as described above) may be applicable to coding complexity measures related to spatial sub-sampling.
According to an embodiment, the encoder 14 may be configured to determine the measure of deviation (e.g., Vᵢ−Vₘₑₐₙ) of the respective frame 10 from the reference set (e.g., all previous frames, all frames, a current group of frames or a previous group of frames) of one or more frames in terms of the at least one predetermined coding complexity measure for the respective frame by determining a deviation measure (e.g. absolute difference such as |Vᵢ−Vₘₑₐₙ| or |Vᵢ−σ|) between the current average (e.g., Vᵢ) of at least one predetermined coding complexity measure and a linearly scaling measure of variability (e.g., one which linearly scales with a scaling of the sample values such as mean value Vₘₑₐₙ of complexity measures or a standard deviation) of sample values of the at least one predetermined coding complexity measure determined (e.g. based on the spatially sub-sampled version 13 of the media signal 11) at each of the different spatial frame portions within the reference set of one or more frames. For example, the deviation measure may be determined based on (or as) an absolute difference between the current average of at least one predetermined coding complexity measure and a mean of coding complexity measures (e.g., as or based on |Vᵢ−Vₘₑₐₙ|).
According to an embodiment, the encoder 14 may be configured to determine the measure of deviation (e.g., R1) of the respective frame (e.g., with index i) from the reference set of one or more frames (e.g., all previous frames, all frames, a current group of frames or a previous group of frames) in terms of the at least one predetermined coding complexity measure for the respective frame by additionally forming a ratio between the deviation measure and the linearly scaling measure of variability (e.g., the standard deviation σ). For example the measure of deviation may be determined based on (or as)

$$R 1 = \frac{\vert {V}_{i} - {V}_{mean} \vert}{σ} or R 1 = \frac{\vert {V}_{i} - σ \vert}{σ} .$$

b) A ratio of VisualActivities of neighboring frame(s) (e.g., individually or as groups of pictures), e.g. ratio R2 of an arithmetic mean over one GOP V_{meanGop} to an entire arithmetic mean Vₘₑₐₙ (e.g., of all frames of the media signal or all previous frames, e.g., the spatially sub-sampled version thereof) or ratio R3 of an arithmetic mean over one GOP V_{meanGop} to an arithmetic mean V_{meanGop-1} over a previous GOP (e.g., a previous GOP that immediately precedes a current GOP):

$$R 2 = \frac{{V}_{meanGop}}{{V}_{mean}} \qquad equation ( 9 )$$

$$R 3 = \frac{{V}_{meanGop}}{{V}_{meanGop - 1}} \qquad equation ( 10 )$$

According to an embodiment, the encoder 14 may be configured to determine (e.g. based on the spatially sub-sampled version 13 of the media signal 11) the at least one predetermined coding complexity measure (e.g. R2, R3) for each of the frames 10 by determining sample values for the at least one predetermined coding complexity measure at each of different spatial frame portions within a frame group (e.g. GOP) which the respective frame 10 belongs to and averaging (e.g. arithmetic mean) over the sample values to obtain an current average (e.g., V_{meanGOP}) of at least one predetermined coding complexity measure.
According to an embodiment, the encoder 14 may be configured to determine the measure of deviation of the respective frame from the reference set of one or more frames in terms of the at least one predetermined coding complexity measure for the respective frame by determining a ratio between the current average of at least one predetermined coding complexity measure (e.g., V_{meangroup}) and a reference average of the at least one predetermined coding complexity measure determined for the reference set of one or more frames which comprises a previous frame group (e.g., V_{meangroup-1}, e.g., R4) or all previous frames (e.g., Vₘₑₐₙ, e.g., R3), including or excluding the respective frame.
c) A ratio of the subsampled and full-resolution metrics, e.g. R4 using the visual activity [2];

$$R 4 = \frac{{VisualActivity}_{Subsampled , i}}{{VisualActivity}_{FullResolution , i}} \qquad equation ( 11 )$$

Alternatively or additionally, to account for a distortion of the signal caused by the resolution sub-sampling, e.g., with step S, instead of VisualActivity, the MMEEᵢ calculated in the first and second passes can be compared with each other (see, for example, FIG. 14).
According to an embodiment, the encoder 14 may be configured to determine, based on the not spatially sub-sampled version 15 of the media signal, at least one full-resolution coding complexity measure (e.g., VisualActivity_{Fullresolution,i}) for each of the frames 10, and determine, for each of the frames, the start QP 58 for respective frame based on the first bit rate obtained for the respective frame, and a further measure of deviation (e.g. R4) between the at least one full-resolution coding complexity measure (e.g., VisualActivity_{Fullresolution,i}) for the respective frame and a corresponding at least one predetermined coding complexity measure (e.g., VisualActivity_{subsampled,i}) determined for the respective frame based on the spatially sub-sampled version 13 of the media signal 11. The measure of deviation may form a ratio of coding complexity measures between the predetermined coding complexity measure and the full-resolution coding complexity measure. The measure of deviation may indicate how much the coding complexity measure changes due to the spatial sub-sampling and may therefore be used as a basis for obtaining the start QP 58.
According to an embodiment, the encoder 14 may be configured to determine the further measure of deviation (e.g., R4) by forming a ratio between the at least one full-resolution coding complexity measure for the respective frame and the corresponding at least one predetermined coding complexity measure determined for the respective frame based on the spatially sub-sampled version of the media signal.

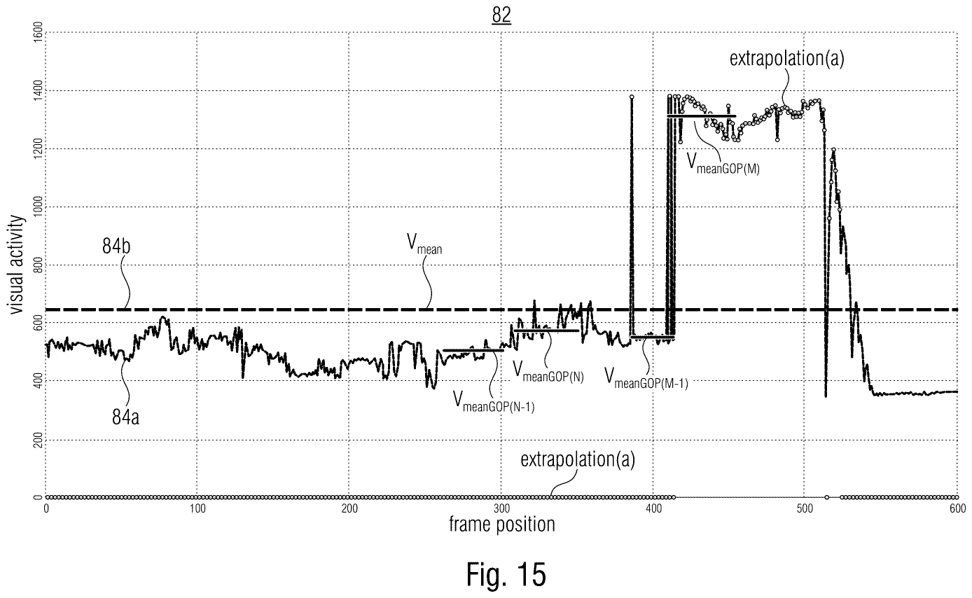

FIG. 15 shows a diagram 82 of an example for deviations of average predetermined coding complexity measures (e.g., in form of visual activity) relative to a reference average. The horizontal axis indicates a position or index of frames 10 encoded in subsequent order (e.g., frame 1 to frame 600). The vertical axis indicates a value for a visual activity (e.g., for values between 0 and 1600) determined for a frame position. A first line 84a shows a visual activity of individual frames. A second line 84b shows a reference average in form of Vₘₑₐₙ (e.g., an average visual activity determined for all frames or a portion of all frames). For exemplary groups of pictures are determined current (e.g., V_{meanGop(N)} and V_{meanGop(M)}) and previous (e.g., V_{meanGop(N-1)} and V_{meanGop(M-1)}) average of at least one predetermined coding complexity measure. As can be seen in FIG. 15, the predetermined coding complexity measure is noticeable different for the GOP M compared to GOPs M-1, N, and N-1. Therefore, the start QP 58 for GOP M may need to be adjusted, for example by increasing an amount of bit allocated to GOP M. The identification of GOP M will be exemplarily described in the following by using the predetermined coding complexity measures R2 and R3. However, any other predetermined coding complexity measure may be used additionally or alternatively.

For example, the measure of deviation may be determined based on (or as) a ratio between a current average of at least one predetermined coding complexity measure (e.g., V_{meanGop(N)} and V_{meanGop(M)}) and a reference average of the at least one predetermined coding complexity measure determined for the reference set of one or more frames which comprises a previous frame group (e.g., V_{meanGop(N-1)} and V_{meanGop(M-1)}). As can be seen in FIG. 15, the predetermined coding complexity measures V_{meanGop(N)} and V_{meanGop(N-1)} differ less than V_{meanGop(M)} and V_{meanGop(M-1)}. As a result, the ratio R3 is closer to one for index N than for index M. Therefore, GOP M may be identified by comparing R3 to a threshold such as a threshold of two.

In a different example, the measure of deviation may be determined based on (or as) a ratio between a current average of at least one predetermined coding complexity measure (e.g., any of V_{meanGop(N)}, V_{meanGop(M)}, V_{meanGop(N-1)}, and V_{meanGop(M-1)}) and a reference average of the at least one predetermined coding complexity measure determined for the reference set of one or more frames which comprises all previous frames (e.g., Vₘₑₐₙ), including or excluding the respective frame. However, any other way for determining the predetermined coding complexity measure may be used (e.g., using individual frames or group of frames). The coding complexity measure of GOP M is significantly further away from Vₘₑₐₙ than the coding complexity measures of GOPs M-1, N, and N-1. Such a deviation is reflected in a larger value for the ratio R4. Therefore, GOP M may be identified by R4 exceeding a threshold (e.g., 1.4).

According to an embodiment, the encoder may be configured to determine, for each of the frames 10, the start QP 58 for respective frame 10 by checking whether the measure of deviation (e.g. R1, R2, R3) exceeds a predetermined threshold (e.g., TH1, TH2, TH3 as described further below), and, if the measure of deviation exceeds the predetermined threshold, setting the start QP 58 so that same corresponds to a finer quantization (e.g., smaller QP) than compared to if the measure of deviation does not exceed the predetermined threshold. For example, the measure of deviation may be based on (or be) R1 (as defined above), if the measure of deviation R1 is greater than a threshold TH1 (e.g., with TH1 in an interval of 1 to 3, e.g., in an interval between 1.5 and 2.5, e.g., with TH1 having a value of 2), the start QP 58 may be set so that same corresponds to a finer quantization (e.g., smaller QP, e.g., by a fixed value such as −1 or −2 or a scaling factor, e.g., by a scaling factor that is fixed or variable, e.g., dependent on Vₘₑₐₙ, Vᵢ or R1) than compared to if the measure of deviation does not exceed the predetermined threshold.

Alternatively or additionally, the encoder 14 may be configured to determine, for each of the frames 10, the start QP 58 for respective frame 10 by checking whether the measure of deviation (e.g. R2, R3) is lower than a predetermined threshold (e.g., TH1, TH2, TH3), and, if the measure of deviation is lower than the predetermined threshold, setting the start QP 58 so that same corresponds to a finer quantization (e.g., smaller QP) than compared to if the measure of deviation is not lower than the predetermined threshold.

For example, the encoder 14 may be configured to check whether the measure of deviation (e.g., R1, R2, R3) is within two thresholds, e.g., greater than a first threshold and smaller than a second threshold. For example, the encoder 14 may be configured to check, whether R2 is smaller than a threshold TH21 and greater than a threshold TH22. For example, the encoder 14 may be configured to check, whether R3 is smaller than a threshold TH31 and greater than a threshold TH32. For example, TH21 or TH31 may have a value in an interval between 1 and 2, e.g., 1.4. For example, TH22 or TH32 may have a value in an interval between 0 and 1, e.g., 0.6. The use of two thresholds (e.g., the measure of deviation being between a first and second threshold) may be applicable to any other measure of deviation as well (e.g., R1).

If the measure of deviation is within such two thresholds, the start QP 58 may be set so that same corresponds to a finer quantization (e.g., smaller QP, e.g., by a fixed value such as −1 or −2 or a scaling factor, e.g., by a scaling factor that is fixed or variable, e.g., dependent on Vₘₑₐₙ, Vᵢ or R1) than compared to if the measure of deviation does not exceed the predetermined threshold. More than two thresholds may be used. Furthermore, it may be checked whether the measure of deviation is outside a range between two thresholds.

Alternatively or additionally, the encoder 14 may be configured to determine, for each of the frames 10, the start QP 58 for respective frame 10 by setting the start QP 58 so that a quantization accuracy which the start QP 58 is associated with monotonically increases (e.g., non-decreasing) with the measure of deviation.

In case any of the requirements regarding one or more thresholds has been met (e.g., R1 being greater than TH1), the encoder 14 maybe configured to determine, for each of the frames, a start QP 58 based on the first bit rate obtained for the respective frame. Similarly, the encoder 14 may be configured to determine, for each of the frames, an amount (or number) of bits allocated (or used) for the frame (or a group of frames). Commonly, the start QP 58 can directly relate to the amount of bits used for a frame, e.g., since a smaller start QP 58 requires more bits to encode a value and vice versa. Therefore, any disclosure herein related to determining a start QP 58 for a frame 10 may alternatively relate to determining an amount (or number) of bits allocated to (or used for) a frame 10.

For example, the encoder 14 may be configured to convert the probe QP 56 (or number of bits allocated to a frame in the first pass) to a start QP 58 (or a number of bits allocated to a frame in the second pass) using a function (e.g., a factor) that dependents on whether the measure of deviation (e.g., whether the measure of deviation falls below a threshold, above a threshold or between two thresholds).

For example, the encoder 14 may be configured to determine a number of bits for a frame in the second pass (or a start QP 58) by scaling number of bits allocated to a frame in the first pass by a factor F1 (e.g., with F1 greater than 1, e.g., F1=2) if the measure of deviation (e.g., R1) does not exceed a threshold (e.g., TH1, e.g., R1 TH1). The encoder 14 may further be configured to determine the number of bits for a frame in the second pass (or a start QP 58) by scaling number of bits allocated to a frame in the first pass by a factor F2 (e.g., with F2 greater than F1, e.g., F2=3) if the measure of deviation (e.g., R1) exceeds a threshold (e.g., TH1, e.g., R1>TH1). The factor F1 may be 2 and the factor F2 may b3, for example, if the sub-sampling comprises a halving of a width and height of a frame 10 (e.g., with step S=2). In the case of determining (e.g., modifying or rescaling) the QP, the start QP may be determined based on the probe QP divided by the same (or similar factor). For example, the start QP may be determined by dividing the probe QP 56 by F1 or F2, respectively (e.g., start QP=(probe QP)/F1 if R1 TH1). The rescaling of the quantization parameter may further comprise the use of a rounding function (e.g., rounding up, down, or to the nearest integer).

In other words, if the deviation is higher or lower than predefined values, e.g.,
a. a deviation measure exceeding a threshold, e.g., R1>TH1, e.g., with e.g. TH1=2; and/or
b. a deviation measure exceeding a first threshold and falling below a second threshold, e.g., TH21>R2>TH22 or TH31>R3>TH32, e.g. TH21=TH31=1.4, e.g., TH22=TH32=0.6; and/or
c. a deviation measure related to a full-resolution coding complexity measure and for the respective frame based on the spatially sub-sampled version of the media signal exceeding a threshold, e.g., R4>TH4, e.g. TH4=1.2, a number of allocated bits may be increased.

For example, the encoder 14 may be configured to increase the number of bits allocated to the one frame or group of frames which results in a finer quantization step size (e.g., in a smaller value for start QP 58), e.g. decreasing the QP value. The default derivation of bits for the 2^{nd} pass from the 1^{st} pass may be

$${numBits}_{i \_ 2. pass} = {numBits}_{i} \cdot {F}_{1} \qquad equation ( 12 )$$

and may be increased to

$${numBits}_{i \_ 2. pass} = {numBits}_{i} \cdot {F}_{2} \qquad equation ( 13 )$$

where F₁<F₂, and F₁>1. For the case S=2, halving both dimensions (width and height), these values may be defined as: F₁=2, F₂=3.

For example, a default derivation of bits for the second pass from the first pass from could be realized for example using the following equation

$${numBits}_{i \_ 2. pass} = {numBits}_{i} ≪ ( S - 1 ) = {numBits}_{i} \cdot {2}^{S - 1} \qquad equation ( 14 )$$

and increased (e.g., when the deviation measure fulfills a criterion related to a threshold) to

$${numBits}_{i \_ 2. pass} = {numBits}_{i} \cdot ( S + 1 ) . \qquad equation ( 15 )$$

According to an embodiment, the encoder 14 may be configured to detect scene changes 64. The encoder 14 may be configured to select only frames from a common scene (e.g., by separating the media sample 11 at scene changes in order to obtain portions of the media sample 11 that each contain only one scene, or a transition or both). The encoder 14 may be configured to perform, on a scene-by-scene basis (e.g., separated by scene changes 64) at least one of the spatial sub-sampling the media signal 11, the first-pass encoding 50, the second-pass encoding 60, and determining a predetermined coding complexity measure of a reference set.

According to an embodiment, the encoder 14 may be configured to determine the at least one predetermined coding complexity measure for each of the frames 10 based on the spatially sub-sampled version 13 of the media signal 11. The encoder complexity may therefore be reduced.

According to an embodiment, the encoder 14 may be configured to determine, based on the spatially sub-sampled version 13 of the media signal 11, one or more coding complexity measures for each of the frames 10, and determine the probe QP 56 for each of the frames 10 based on the one or more coding complexity measures determined for the respective frame, wherein the at least one predetermined coding complexity measure is comprised by the one or more coding complexity measures.

In order to take advantage of scene changes in the input (e.g., scene changes 64 in the media sample 11), the adjustments described above (e.g., determining an amount of bits allocated to a frame) can alternatively or optionally be made separately within each scene instead of for the entire input (e.g., within portions of the media sample 11 that are separated by scene changes 64). It is also possible to operate inside one or multiple GOPs.

Advantages may comprise a reduced first pass runtime. Furthermore, the same or similar process flow may be used inside one GOP as in the original non sub-sampling RC method.

In case of one-pass operation, where each picture may only be read once, additional steps like pre-filtering may need to be performed twice, e.g., for full-resolution pictures 10 as well as subsampled pictures 10. Therefore, two-pass operation may be more beneficial (where each input frame is read and processed two times either way, once for each pass).

The encoder 14 may be configured to not perform (or skip) a pre-filtering of the spatially sub-sampled version 13 of the media sample 11. In other words, to further speedup the encoding process, a pre-filtering of the subsampled frames used for the first pass, might be skipped completely (e.g., at the cost of a reduced accuracy of the statistics, generated by the analysis stage. The encoder 14 may be configured to perform a pre-filtering (e.g., motion compensated temporal filtering) before performing the spatial sub-sampling. In other words, the subsampling might be executed after the pre-filter has been applied, which, for example, specifically targets the one-pass look ahead use case.

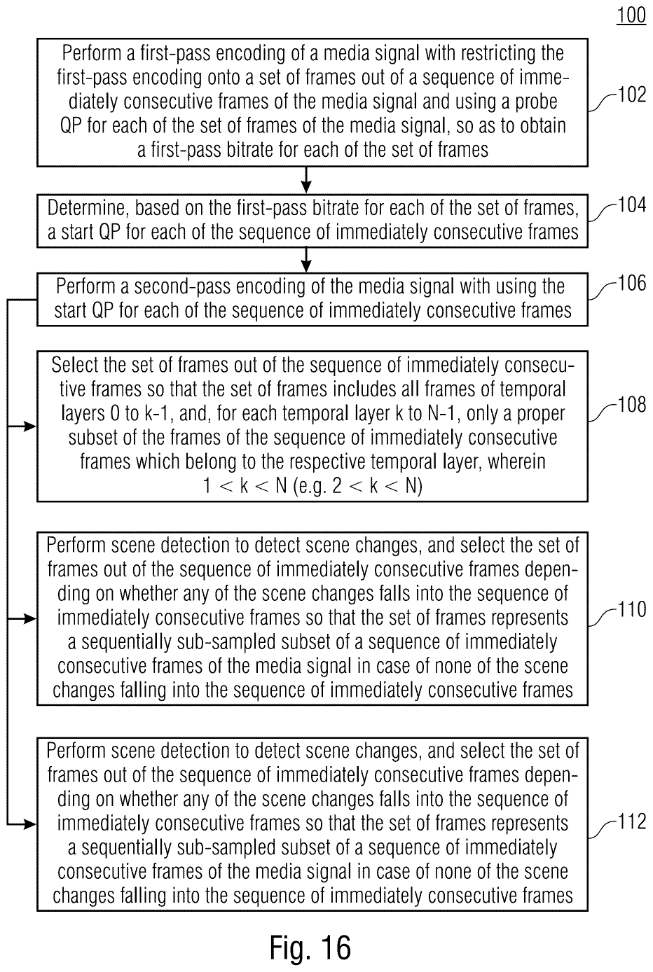

FIG. 16 shows a method 100 for encoding a media signal 11. The method may be performed by the encoder 14.

The method 100 comprises, in step 102, performing a first-pass encoding 50 of the media signal 11 with restricting the first-pass encoding 50 onto a set 52 of frames 10 out of a sequence 54 of immediately consecutive frames 10 of the media signal 11 and using a probe QP 56 for each of the set 52 of frames 10 of the media signal 11, so as to obtain a first-pass bitrate for each of the set 52 of frames 10.

The method 100 further comprises, in step 104, determining, based on the first-pass bitrate for each of the set 52 of frames 10, a start QP 58 for each of the sequence 54 of immediately consecutive frames 10.

The method 100 perform a second-pass encoding 60 of the media signal 11 with using the start QP 58 for each of the sequence 54 of immediately consecutive frames 10.

The method 100 further defines at least one of the following three aspects.

The sequence 54 of immediately consecutive frames 10 is a group of pictures (GOP; e.g. GOP #1 in FIG. 4) having a hierarchical referencing structure with temporal layers 62 including a temporal base layer 0 (e.g. a temporal layer 0 inevitably to be decoded; e.g. TLO in FIG. 4) up to a highest temporal layer N-1 (e.g. and temporal layers 0<n<N the decoding which necessitates a previous decoding of temporal layers m<n; e.g. TL3 in FIG. 4) and the method 100 comprises in an aspect i), in step 108, selecting the set of frames (e.g. those encircled among the eight ones of GOP #1 in FIG. 4) out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N (e.g. 2<k<N) (e.g. k=3 in FIG. 4).

The method comprises in an aspect ii), in step 110, performing scene detection to detect scene changes, and selecting the set 52 of frames out of the sequence 54 of immediately consecutive frames depending on whether any of the scene changes 64 falls into the sequence 54 of immediately consecutive frames 10 so that the set 52 of frames 10 represents a sequentially sub-sampled subset (e.g. those encircled out of GOP #1 in FIG. 4) of a sequence 54 of immediately consecutive frames 10 of the media signal 11 in case of none of the scene changes 64 falling into the sequence 54 of immediately consecutive frames.

The method comprises in an aspect iii), in step 112, performing scene detection to detect scene changes 64 separating scenes, and determining, based on the first-pass bitrate for each of the set 52 of frames 10, the start QP 58 for each of the sequence 54 of immediately consecutive frames 10 in a manner depending on the scene changes 64 so that, for each of the sequence 54 of immediately consecutive frames 10, the start QP 58 is exclusively determined based on the first-pass bitrate of one or more frames 10 within the set 52 of frames 10, which fall into a scene into 64 which the respective frame falls.

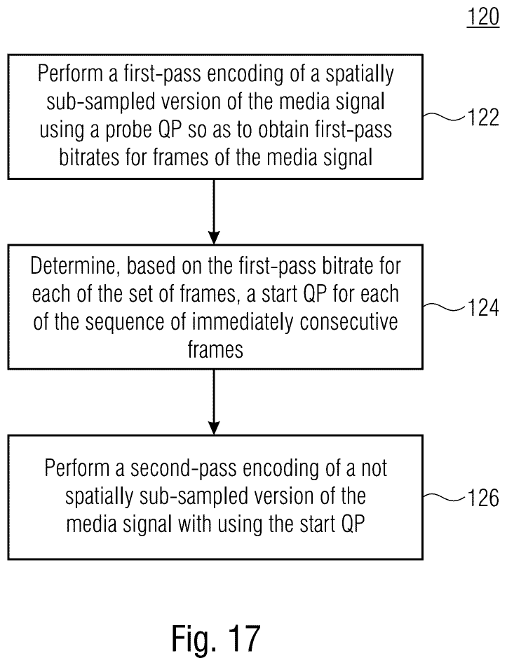

FIG. 17 shows a method 120 for encoding a media signal 11. The method may be performed by the encoder 14.

The method 120 comprises, in step 122, performing a first-pass encoding 50 of a spatially sub-sampled version 13 of the media signal 11 using a probe QP 56 so as to obtain first-pass bitrates for frames 10 of the media signal 11.

The method 120 comprises, in step 124, determining, based on the first-pass bitrates, start QPs 58 for the frames 10 of the media signal 11.

The method 120 comprises, in step 126, performing a second-pass encoding 60 of a not spatially sub-sampled version 15 of the media signal 11 with using the start QPs 58.

Any of the methods 100 and 120 may further include any functionality or method step of the encoder 14 disclosed herein.

### Combination of Temporal and Spatial Sub-Sampling

The described inventions can act separately and as a combination. For example, in a combined approach, the temporal subsampling may predict the bitrate (e.g., determine start QP 58) for frames 10 not encoded in the first pass 50 by extrapolating it from the bits predicted for the frames encoded in spatially subsampled manner (e.g., the spatial subsampling extrapolation for the first-pass encoded frames 10 may be applied first, and be then used for the temporal subsampling extrapolation for the not encoded frames).

According to an embodiment, the encoder 14 for temporal sub-sampling may be configured to perform the first-pass encoding 50 at a spatially sub-sampled version 13 of the media signal 11. Therefore, the encoder 14 may be configured to perform any feature of the encoder 14 for spatial sub-sampling as described herein. According to an embodiment, the encoder 14 (for temporal sub-sampling) may be configured to operate according to any embodiment described herein with reference to spatial sub-sampling.

According to an embodiment, the encoder 14 for spatial sub-sampling may be configured to perform the first-pass encoding 50 at a temporally sub-sampled manner and the second-pass encoding 60 at a non-temporally sub-sampled manner, and derive start QPs 58 for frames 10 not coded in the first-pass encoding 50 by means of the first-pass bitrates of frames coded by the first-pass encoding 50. According to an embodiment, the encoder 14 (for spatial sub-sampling) may be configured to operate according to any embodiment described herein with reference to temporal sub-sampling.

Further is provided a computer program (or computer program product) having a program code (or computer instructions) for performing, when running on one or more processors (or computer) any method disclosed herein. The encoder 14 may be a computer that has the computer program. The computer program may be stored on a non-transitory storage medium.

Further provided is a data stream having encoded therein a media signal 11 using any method disclosed therein. Any encoder 14 disclosed herein may be configured to generate the data stream.

### General Remarks

Note that, in all of the abovementioned descriptions and proposals, the terms “frame”, “picture”, “image” may be used interchangeably: a frame usually describes a collection of one or more pictures which, in turn, may also be known as an image. Note, also, that chroma-component data may be used instead of, or in addition to, luma value. Furthermore, any other form of planes may be used (e.g., green, blue, red components).

### Further Remarks

Above, different inventive embodiments and aspects have been described in a chapter “temporal sub-sampling” and in a chapter “spatial sub-sampling”.

Also, further embodiments will be defined by the enclosed claims.

It should be noted that any embodiments as defined by the claims can be supplemented by any of the details (features and functionalities) described in the above mentioned chapters.

Also, the embodiments described in the above mentioned chapters can be used individually, and can also be supplemented by any of the features in another chapter, or by any feature included in the claims.

Also, it should be noted that individual aspects described herein can be used individually or in combination. Thus, details can be added to each of said individual aspects without adding details to another one of said aspects.

It should also be noted that the present disclosure describes, explicitly or implicitly, features usable in video encoder (apparatus for providing an encoded representation of an input video signal). Thus, any of the features described herein can be used in the context of a video encoder.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”.

Also, any of the features and functionalities described herein can be implemented in hardware or in software, or using a combination of hardware and software, as will be described in the section “implementation alternatives”.

### Implementation Alternatives

Although some aspects have been described in the context of an apparatus (e.g., encoder), it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable. The encoded media signal may be encoded into a data stream. The data stream may be stored on a digital storage medium as described above (e.g., a transitory digital storage medium).

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier (e.g., non-transitory storage medium).

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following ap-pended claims be interpreted as including all such alterations, permutations and equivalents as fall within the true spirit and scope of the present invention.

### REFERENCES

[1]H. Schwarz, D. Marpe, and T. Wiegand, “Analysis of Hierarchical B Pictures and MCTF,” 2006 IEEE International Conference on Multimedia and Expo, 2006, pp. 1929-1932, doi: 10.1109/ICME.2006.262934.
[2]C. R. Helmrich, I. Zupancic, J. Brandenburg, V. George, A. Wieckowski and B. Bross, “Visually Optimized Two-Pass Rate Control for Video Coding Using the Low-Complexity XPSNR Model,” 2021 International Conference on Visual Communications and Image Processing (VCIP), Munich, Germany, 2021, pp. 1-5, doi: 10.1109/VCIP53242.2021.9675364.
[3]C. R. Helmrich et al., “A Scene Change and Noise Aware Rate Control Method for VVenC, An Open VVC Encoder Implementation,” 2022 Picture Coding Symposium (PCS), San Jose, CA, USA, 2022, pp. 241-245, doi: 10.1109/PCS56426.2022.10018041.

1. Encoder for encoding a media signal, configured to
perform a first-pass encoding of the media signal with restricting the first-pass encoding onto a set of frames out of a sequence of immediately consecutive frames of the media signal and using a probe QP for each of the set of frames of the media signal, so as to acquire a first-pass bitrate for each of the set of frames,
determine, based on the first-pass bitrate for each of the set of frames, a start QP for each of the sequence of immediately consecutive frames; and
perform a second-pass encoding of the media signal with using the start QP for each of the sequence of immediately consecutive frames,
one or more of the following is provided:
(i) the sequence of immediately consecutive frames is a group of pictures having a hierarchical referencing structure with temporal layers including a temporal base layer 0 up to a highest temporal layer N-1 and the encoder is configured to select the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N;
(ii) the encoder is configured to perform scene detection to detect scene changes, and select the set of frames out of the sequence of immediately consecutive frames depending on whether any of the scene changes falls into the sequence of immediately consecutive frames so that the set of frames represents a sequentially sub-sampled subset of a sequence of immediately consecutive frames of the media signal in case of none of the scene changes falling into the sequence of immediately consecutive frames and
(iii) the encoder is configured to perform scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respective frame falls.

2. Encoder of claim 1, wherein the first-pass encoding involves an encoder-search space which is reduced compared to the second-pass encoding.

3. Encoder of claim 1, wherein the first-pass encoding operates using rate-distortion optimization at variable rate and the second-pass encoding operates using rate-distortion optimization in a rate-controlled manner.

4. Encoder of claim 1, wherein the encoder is configured to
perform the first-pass encoding onto consecutive sequences of immediately consecutive frames of the media signal before performing the second-pass encoding onto each of the consecutive sequences of immediately consecutive frames or
perform the first-pass encoding and the second-pass encoding onto consecutive sequences of immediately consecutive frames of the media signal in an interleaved manner.

5. Encoder of claim 1, configured to determine, based on the first-pass bitrate for each of the set of frames, the start QP for each of the sequence of immediately consecutive frames by
determining, for each frame of the sequence of immediately consecutive frames, which is not comprised by the set of frames, a first-pass bitrate based on the first-pass bitrate for each of the set of frames, and
determining, for each frame of the sequence of immediately consecutive frames, the start QP based on the first-pass bitrate of the respective frame.

6. Encoder of claim 5, configured to determine, for each frame of the sequence of immediately consecutive frames, which is not comprised by the set of frames, the first-pass bitrate based on the first-pass bitrate for each of the set of frames by selecting one or more frames out of the set of frames having a temporal layer associated therewith which equals the temporal layer of the respective frame.

7. Encoder of claim 1, wherein N=6 or 5 and k=3.

8. Encoder of claim 1, wherein N=6 and k=3 and a size of the GOP is 32 or N=5 and k=3 and a size of the GOP is 16.

9. Encoder of claim 1, wherein
the sequence of immediately consecutive frames is a group of pictures, GOP, having a hierarchical referencing structure with temporal layers including a temporal base layer 0 up to a highest temporal layer N-1 and the encoder is configured to select the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, and
the encoder is configured to perform scene detection to detect scene changes, and select k and/or select the proper subset for each of the temporal layers k to N-1 depending on whether any of the scene changes falls into the GOP.

10.-20. (canceled)

21. Encoder for encoding a media signal, configured to
perform a first-pass encoding of a spatially sub-sampled version of the media signal using a probe QP so as to acquire first-pass bitrates for frames of the media signal,
determine, based on the first-pass bitrates, start QPs for the frames of the media signal; and
perform a second-pass encoding of a not spatially sub-sampled version of the media signal with using the start QPs.

22. Encoder of claim 21, configured to
determine, based on the spatially sub-sampled version of the media signal, one or more coding complexity measures for each of the frames, and
determine the probe QP for each of the frames based on the one or more coding complexity measures determined for the respective frame.

23. Encoder of claim 21, configured to
determine at least one predetermined coding complexity measure for each of the frames, and
determine, for each of the frames, the start QP for respective frame based on
the first bit rate acquired for the respective frame, and
the at least one predetermined coding complexity measure for the respective frame.

24. Encoder of claim 21, configured to
determine at least one predetermined coding complexity measure for each of the frames, and
determine, for each of the frames, the start QP for respective frame based on
the first bit rate acquired for the respective frame, and
a measure of deviation of the respective frame from a reference set of one or more frames in terms of the at least one predetermined coding complexity measure for the respective frame.

25. Encoder of claim 24, configured to
determine the at least one predetermined coding complexity measure for each of the frames by
determining sample values for the at least one predetermined coding complexity measure at each of different spatial frame portions within the respective frame and averaging over the sample values to acquire a current average of at least one predetermined coding complexity measure.

26. Encoder of claim 25, configured to
determine the measure of deviation of the respective frame from the reference set of one or more frames in terms of the at least one predetermined coding complexity measure for the respective frame by
determining a deviation measure between the current average of at least one predetermined coding complexity measure and a linearly scaling measure of variability of sample values of the at least one predetermined coding complexity measure determined at each of the different spatial frame portions within the reference set of one or more frames.

27. Encoder of claim 26, configured to
determine the measure of deviation of the respective frame from the reference set of one or more frames in terms of the at least one predetermined coding complexity measure for the respective frame by
additionally forming a ratio between the deviation measure and the linearly scaling measure of variability.

28. Encoder of claim 24, configured to
determine the at least one predetermined coding complexity measure for each of the frames by
determining sample values for the at least one predetermined coding complexity measure at each of different spatial frame portions within a frame group which the respective frame belongs to and averaging over the sample values to acquire an current average of at least one predetermined coding complexity measure.

29. Encoder of claim 28, configured to
determine the measure of deviation of the respective frame from the reference set of one or more frames in terms of the at least one predetermined coding complexity measure for the respective frame by
determining a ratio between the current average of at least one predetermined coding complexity measure and a reference average of the at least one predetermined coding complexity measure determined for the reference set of one or more frames which comprises a previous frame group or all previous frames, including or excluding the respective frame.

30.-50. (canceled)

51. Data stream having encoded therein a media signal using a method for encoding a media signal, the method comprising
performing a first-pass encoding of the media signal with restricting the first-pass encoding onto a set of frames out of a sequence of immediately consecutive frames of the media signal and using a probe QP for each of the set of frames of the media signal, so as to acquire a first-pass bitrate for each of the set of frames,
determining, based on the first-pass bitrate for each of the set of frames, a start QP for each of the sequence of immediately consecutive frames; and
performing a second-pass encoding of the media signal with using the start QP for each of the sequence of immediately consecutive frames,
wherein the method comprises at least one of
(i) the sequence of immediately consecutive frames is a group of pictures having a hierarchical referencing structure with temporal layers including a temporal base layer 0 up to a highest temporal layer N-1 and the method comprise selectin the set of frames out of the sequence of immediately consecutive frames so that the set of frames includes all frames of temporal layers 0 to k-1, and, for each temporal layer k to N-1, only a proper subset of the frames of the sequence of immediately consecutive frames which belong to the respective temporal layer, wherein 1<k<N,
(ii) wherein the method comprises performing scene detection to detect scene changes, and select the set of frames out of the sequence of immediately consecutive frames depending on whether any of the scene changes falls into the sequence of immedi-ately consecutive frames so that the set of frames represents a sequentially sub-sampled subset of a sequence of immediately consecutive frames of the media signal in case of none of the scene changes falling into the sequence of immediately consecutive frames, and
(iii) wherein the method comprises performing scene detection to detect scene changes separating scenes, and determine, based on the first-pass bitrate for each of the set of frames, the start QP for each of the sequence of immediately consecutive frames in a manner depending on the scene changes so that, for each of the sequence of immediately consecutive frames, the start QP is exclusively determined based on the first-pass bitrate of one or more frames within the set of frames, which fall into a scene into which the respec-tive frame falls.

52. Data stream having encoded therein a media signal using a method for encoding a media signal, the method comprising
performing a first-pass encoding of a spatially sub-sampled version of the media signal using a probe QP so as to acquire first-pass bitrates for frames of the media signal,
determining, based on the first-pass bitrates, start QPs for the frames of the media signal; and
performing a second-pass encoding of a not spatially sub-sampled version of the media signal with using the start QPs.
